(19) United States
(12) Patent Application Publication
(10) Pub. No.: US 2016/0154769 A1
(43) Pub. Date: Jun. 2, 2016

(54) ELECTRONIC DEVICE AND METHOD FOR HANDWRITING

(71) Applicant: Kabushiki Kaisha Toshiba, Tokyo (JP)

(72) Inventors: Shogo Ikeda, Tachikawa Tokyo (JP); Tatsuo Yamaguchi, Kunitachi Tokyo (JP); Yuki Kanbe, Ome Tokyo (JP); Toshiyuki Yamagami, Fussa Tokyo (JP)

(21) Appl. No.: 14/693,365

(22) Filed: Apr. 22, 2015

Related U.S. Application Data
(60) Provisional application No. 62/085,435, filed on Nov. 28, 2014.

(51) Int. Cl. G06F 17/21; G06F 3/0484; G06F 3/0488

(52) U.S. Cl. CPC G06F 17/214; G06F 3/04883; G06F 3/04842

(57) ABSTRACT

According to one embodiment, an electronic device receives first stroke data from a first terminal logging in to a service for sharing handwritten information, and second stroke data from a second terminal logging in to the service. The electronic device displays the first stroke data and the second stroke data on a screen. The electronic device changes a display style of the first stroke data from a first style to a second style, when a state of the first terminal is changed from a login state to a logout state, or from the login state to an intermediate state between the login state and the logout state.

### CROSS-REFERENCE TO RELATED APPLICATIONS

This application claims the benefit of U.S. Provisional Application No. 62/085,435, filed Nov. 28, 2014, the entire contents of which are incorporated herein by reference.

### FIELD

Embodiments described herein relate generally to a technique for sharing handwritten information.

### BACKGROUND

In recent years, various kinds of electronic devices such as personal computers (PCs), tablets and smart phones have been developed.

Most of such kinds of electronic devices are provided with touch screen displays to enable users to easily perform an input operation.

Also, in recent years, techniques for causing handwritten information to be shared have been developed. Those techniques are useful when being used in business, for example, a conference.

However, conventionally, it is not considered in technique how strokes input by handwriting by a plurality of persons are presented to a user to enable him or her to easily view them.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an appearance of an electronic device according to an embodiment.

FIG. 2 is an exemplary view illustrating a connection between electronic devices (terminals) using a handwriting sharing service.

FIG. 3 is an exemplary view illustrating a process in which the terminals share the same canvas with each other.

FIG. 4 is an exemplary view illustrating a relationship between a writer and strokes in a screen in which handwritten information is shared among a plurality of electronic devices.

FIG. 5 is an exemplary view for use in explaining by way of example an outline of flows of data between the electronic device (server) as shown in FIG. 1 and other electronic devices.

FIG. 6 is an exemplary view illustrating the screen (canvas), in which handwritten information is shared among the plurality of electronic devices.

FIG. 7 is an exemplary view illustrating a handwritten document that is handwritten on a touch screen display of the electronic device as shown in FIG. 1.

FIG. 8 is an exemplary view illustrating time-series information corresponding to the handwritten document as shown in FIG. 7.

FIG. 9 is an exemplary view illustrating a process in which different displayer styles are assigned to a plurality of terminals.

FIG. 10 is an exemplary view illustrating part of a display style assignment process which is executed in the case where a new terminal participates in.

FIG. 11 is an exemplary view illustrating the other part of the display style assignment process.

FIG. 12 is an exemplary view illustrating an operation for causing handwriting data (stroke data) to be shared.

FIG. 13 is another exemplary view illustrating the operation for causing the handwriting data (stroke data) to be shared.

FIG. 14 is an exemplary view illustrating a process in which strokes of a plurality of persons are displayed in different styles.

FIG. 15 is an exemplary view illustrating a process in which strokes by a participator only selected using a participator list and check boxes are displayed.

FIG. 16 is an exemplary view illustrating a process in which a plurality of strokes input by handwriting by the same participator are displayed in different display styles in accordance with times at which they were input by handwriting.

FIG. 17 is an exemplary view illustrating times at which strokes were input by handwriting by a participator, and times at which strokes were input by handwriting by another participator.

FIG. 18 is an exemplary view illustrating a process in which a plurality of strokes input by handwriting by the same participator are displayed at different brightness levels based on a color assigned to the participator.

FIG. 19 is an exemplary view illustrating a process in which a status list indicating connection states of the participators is delivered to each of the terminals.

FIG. 20 is an exemplary view illustrating a process in which display styles of strokes input by the participators are changed in accordance with the connection states of the participators.

FIG. 21 is a view illustrating an example of connection states of the participators.

FIG. 22 is an exemplary block diagram illustrating a configuration of the electronic device as shown in FIG. 1.

FIG. 23 is an exemplary block diagram illustrating a handwriting sharing program to be executed by the electronic device as shown in FIG. 1.

FIG. 24 is an exemplary view illustrating contents of a stroke database for use by the electronic device as shown in FIG. 1.

FIG. 25 is an exemplary view illustrating contents of a display style list for use by the electronic device as shown in FIG. 1.

FIG. 26 is a flowchart illustrating a procedure of a display style assignment process to be executed by the electronic device as shown in FIG. 1.

FIG. 27 is an exemplary flowchart illustrating a stroke delivering process to be executed by the electronic device as shown in FIG. 1.

FIG. 28 is an exemplary flowchart illustrating a procedure of a stroke display style controlling process to be executed by the electronic device as shown in FIG. 1.

FIG. 29 is an exemplary flowchart illustrating a procedure of a stroke displaying/dismissing process to be executed by the electronic device as shown in FIG. 1.

FIG. 30 is an exemplary flowchart illustrating a procedure of a process for controlling a display style of a stroke based on the time at which the stroke was input by handwriting.

FIG. 31 is an exemplary flowchart illustrating a status control process to be executed by the electronic device as shown in FIG. 1.

### DETAILED DESCRIPTION

Various embodiments will be described hereinafter with reference to the accompanying drawings.

In general, according to one embodiment, an electronic device includes a receiver and circuitry. The receiver receives first stroke data from a first terminal logging in to a service for sharing handwritten information, and second stroke data from a second terminal logging in to the service. The first stroke data corresponds to one or more strokes input by handwriting at the first terminal. The second stroke data corresponds to one or more strokes input by handwriting at the second terminal. The circuitry executes a process for displaying the first stroke data and the second stroke data on a screen. The circuitry changes a display style of the first stroke data from a first style to a second style different from the first style, when a state of the first terminal is changed from a login state to a logout state, or from the login state to an intermediate state between the login state and the logout state.

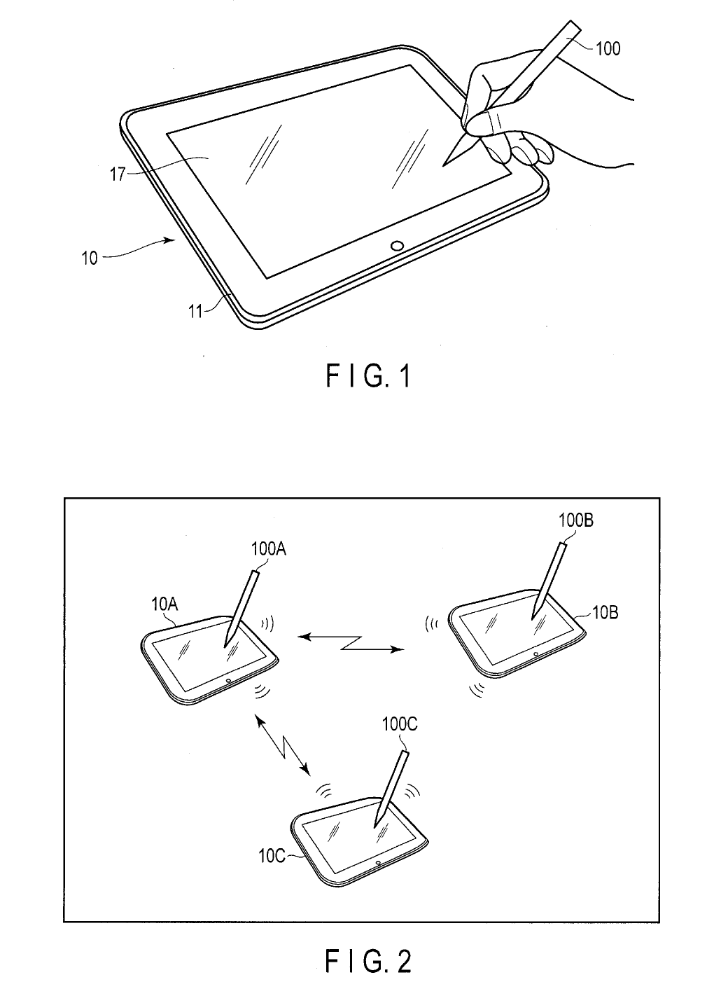

FIG. 1 is a perspective view showing an appearance of an electronic device according to an embodiment. This electronic device is, for example, a portable pen-based electronic device on which a handwriting inputting operation can be performed with a pen (stylus) or a finger. The electronic device can be realized as a tablet computer, a notebook personal computer, a smart phone, a PDA or the like. The following explanation is given with respect to the case where the electronic device is realized as a tablet computer 10. The tablet computer 10 is a portable electronic device also referred to as a tablet or a slate computer. The tablet computer 10, as shown in FIG. 1, comprises a main body 11 and a touch screen display 17. The touch screen display 17 is attached to the main body 11 such that it is laid on an upper surface of the main body 11.

The main body 11 has a housing formed in a shape of a thin box. In the touch screen display 17, a flat panel display and a sensor are provided. The sensor detects a position (contact position) of part of the flat panel display, which the pen or finger contacts. As the flat panel display, for example, a liquid crystal display (LCD) may be provided. Also, as the sensor, for example, a capacitance touch panel or an electromagnetic induction type digitizer can be applied. Those two kinds of sensors, i.e., the digitizer and the touch panel, may be both incorporated in the touch screen display 17.

The touch screen display 17 can detect the position of part of its screen, which the finger or the pen contacts. As a pen 100, for example, an electromagnetic induction pen (digitizer pen) may be applied. A user can write a character or the like on the screen of the touch screen display 17, using an external object (the finger or the pen 100). During such a handwriting inputting operation, a locus of movement of the external object, i.e., a stroke input by handwriting, is drawn in real time on the screen. A locus of movement of the external object, with the external object being in contact with the screen, corresponds to a single stroke. Thus, a handwritten document is formed by a plurality of strokes corresponding to characters or figures input by handwriting.

A single stroke is indicated by a group of point data corresponding to a plurality of points, respectively, on the stroke. Each of the point data indicates coordinates (X coordinate and Y coordinate) of a corresponding point. Although as described above, the external object is either the pen 100 or the finger, the following explanation is given with respect to the case where a handwriting inputting operation is performed using the pen 100.

The tablet computer 10 further has a handwriting collaboration function. The handwriting collaboration function performs a handwriting sharing service in which handwritten information can be shared among a plurality of electronic devices. The handwriting sharing service enables a user of each of the electronic devices to view shared handwritten information, and to edit the handwritten information in corporation with users of the other electronic devices.

In the handwriting sharing service, stroke data input by handwriting in an electronic device participating in (logging in to) the service is delivered in real time to other electronic devices participating in (logging in to) the service. Thereby, those electronic devices can be synthesized with each other with respect to contents of a handwritten document displayed on display screens of the electronic devices. Furthermore, in the handwriting sharing service, stroke data input by handwriting performed by different users can be displayed in different manners (for example, different colors, different widths or different pen types).

The handwriting sharing service is utilized by a group of persons. The group of persons utilizing the handwriting sharing service may include a single owner (sponsor) and one or more participators. The owner is also a member of the group.

FIG. 2 shows a connection between electronic devices using the handwriting sharing service.

An electronic device 10A is a tablet computer for use by a user A. An electronic device 10B is a table computer for use by a user B. An electronic device 10C is a tablet computer for use by a user C. Each of the electronic devices 10A, 10B and 10C has a handwriting collaboration function equivalent to that of the tablet computer 10 according to the embodiment.

The electronic devices 10A, 10B and 10C are connected to each other by a wired network or a wireless network. In the following, suppose the electronic devices 10A, 10B and 100 are connected to each other with the wireless network. As a method of connecting the electronic devices 10A, 10B and 100 to each other, arbitrary wireless connection standards based on which a plurality of devices are wirelessly connected to each other can be applied. For example, Wi-Fi Direct (registered trademark) or Bluetooth (registered trademark) may be applied.

Any one of the electronic devices 10A, 10B and 100 can function as a server configured to manage the handwriting sharing service. Also, the electronic device of an owner may serve as a server. The owner corresponds to an organizer of the handwriting sharing service.

The server may determine whether or not to permit an electronic device requesting participation in the handwriting sharing service to participate in the handwriting sharing service (group); i.e., it may determine whether or not to permit the electronic device to log in to the handwriting sharing service. Only a device (terminal) which receives permission to participate in the group (log in to the service) may be permitted to log in to the handwriting sharing service, i.e., participate in the group.

It should be noted that in each device (terminal), as a method of logging in to the handwriting sharing service, an ID (account) of each device may be applied to log in to the handwriting sharing service. Alternately, an ID (account) of a user of each device may be applied to log in to the handwriting sharing service. That is, as the method of logging in to or logging out from the handwriting sharing service, either the ID (account) of each device or the ID (account) of the user of each device may be applied.

Suppose the electronic devices 10A, 10B and 10C log in to the handwriting sharing service; that is, the electronic devices 10A, 10B and 100 participate in the same handwriting sharing service. In the electronic devices 10A, 10B and 100, a handwriting sharing screen (canvas) for viewing shared handwritten information. The handwriting sharing screen (canvas) is used as a common display area for the electronic devices 10A, 10B and 100. The handwriting sharing screen (canvas) enables visual communication to be carried out between the electronic devices 10A, 10B and 100. The visual communication enables the devices to exchange handwritten information or various electronic documents with each other.

Stroke data input by handwriting by each of the users A, B and C in a device for use by each user is displayed in real time on the handwriting sharing screen (canvas) of the device, and is also reflected on the handwriting sharing screen (canvas) of each of the devices of other users. Thus, stroke data (handwritten characters, handwritten figures or the like) input by handwriting performed by the users A, B and C, respectively, can be exchanged or shared among the users A, B and C.

Furthermore, the electronic devices 10A, 10B and 100 can display the same content such as the same conference material on the canvas. In this case, stroke data input by handwriting at those devices is displayed in the content. While viewing the same content, the users A, B and C can exchange and share handwritten characters, handwritten figures or the like on the content with each other.

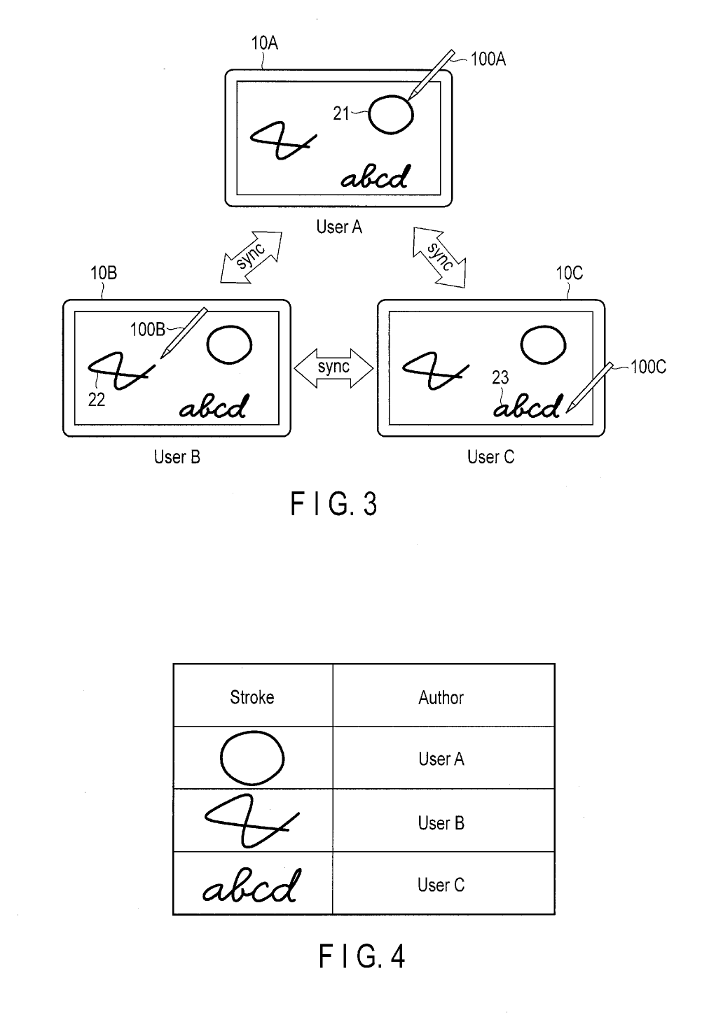

FIG. 3 shows a process in which the electronic devices (terminals) 10A, 10B and 100 share the same canvas with each other.

In the handwriting sharing service, the electronic devices (terminals) 10A, 10B and 10C are wirelessly connected to each other. Also, in the handwriting sharing service, the terminals are synchronized with each other in image displaying operation and handwriting operation, thereby to enable the users of the terminals to perform handwriting inputting operations on the same canvas at the same time.

On the canvases of the electronic devices (terminals) 10A, 10B and 100, the same strokes are displayed, i.e., strokes 21, 22 and 23 are displayed. As shown in FIG. 4, the stroke 21 is a stroke input by handwriting by the user A at the electronic device 10A. The stroke 22 is a stroke input by handwriting by the user B at the electronic device 10B. The stroke 23 is a stroke input by handwriting by the user C at the electronic device 10C.

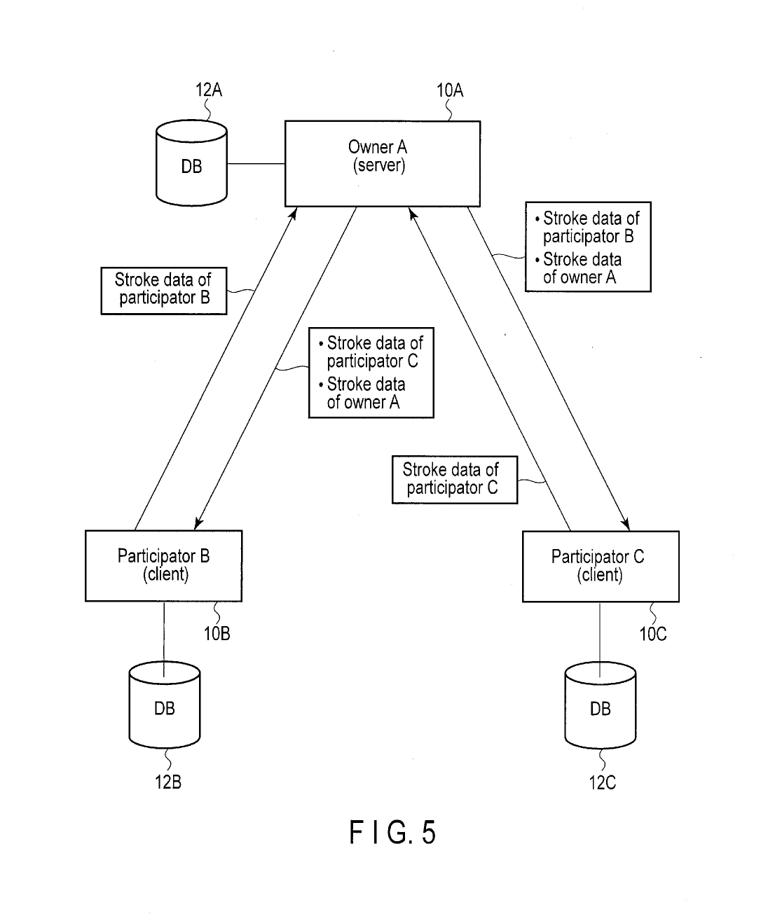

FIG. 5 shows flows of data between the electronic devices.

FIG. 5 also shows the case where the electronic device 10A operates as a server of a system which performs the handwriting sharing service. That is, the user A of the electronic device 10A is an owner (owner A), the user B of the electronic device 10B is a participator (participator B), and the user C of the electronic device 10C is another participator (participator C). The electronic devices 10B and 100 function as clients.

The electronic device 10A receives from the electronic device 10B, stroke data corresponding to a stroke input by handwriting at the electronic device 10B (i.e., stroke data of the participator B). Also, the electronic device 10A receives from the electronic device 10C, stroke data corresponding to a stroke input by handwriting in the electronic device 10C (i.e., stroke data of the participator C).

Furthermore, the electronic device 10A transmits to the electronic device 10B, stroke data corresponding to a stroke input by handwriting at the electronic device 10A (i.e., stroke data of the owner A) and the stroke data received from the electronic device 10C (i.e., the stroke data of the participator C); and also transmits to the electronic device C, the stroke data corresponding to the stroke input by handwriting at the electronic device 10A (i.e., the stroke data of the owner A) and the stroke data received from the electronic device 10B (i.e., the stroke data of the participator B).

Thus, on a display of the electronic device 10A, not only the stroke data of the owner A, but the stroke data of the participator B and the stroke data of the participator C are displayed.

Similarly, on a display of the electronic device 10B, not only stroke data of the participator B, but the stroke data of the owner A and the stroke data of the participator C are displayed.

Also, similarly, on a display of the electronic device 10C, not only the stroke data of the participator C, but the stroke data of the owner A and the stroke data of the participator B are displayed.

Each of the electronic devices 10A, 10B and 10C stores the stroke data corresponding to the stroke input by handwriting at the device in a respective one of local databases (12A, 12B and 12C). Also, each of the electronic devices 10A, 10B and 10C stores the stroke data corresponding to the strokes input by handwriting at the other electronic devices in the respective one of the local databases (12A, 12B and 12C).

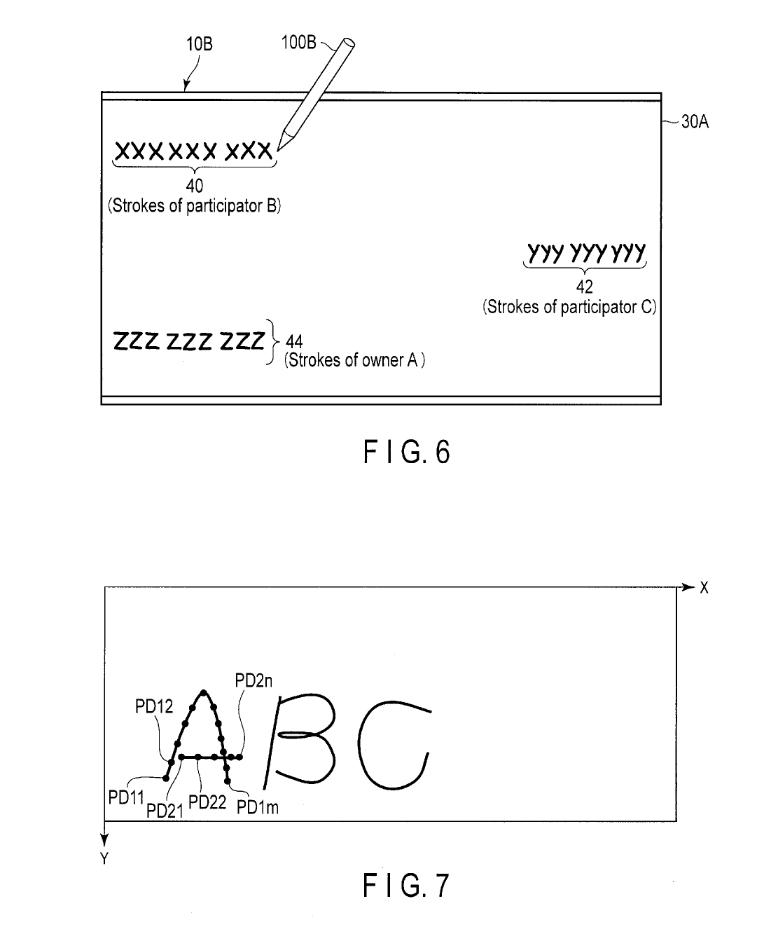

FIG. 6 shows an example of the handwriting sharing screen (canvas). A canvas 30A of each of the electronic devices is a handwriting area. On canvas 30A, stroke data of the users is displayed. It should be noted that such content as a conference material may be displayed on the canvas 30A. In this case, stroke data of each user is displayed on the content.

With respect to the electronic device 10B, on the canvas 30A of the electronic device 10B, strokes 40 input by handwriting with the pen 100B by the participator B on the canvas 30A are displayed. Also, on the canvas 30A, strokes input by handwriting at the other electronic devices are displayed. The stroke data input by handwriting at the other electronic devices include strokes 42 input by handwriting by the participator C at the electronic device 10C and strokes 44 input by handwriting by the owner A at the electronic device 10A.

Next, the stroke data will be explained with reference to FIG. 7.

FIG. 7 shows the case where a string of characters “A”, “B” and “C” are handwritten in this order.

The handwritten character “A” is formed by two strokes input by handwriting with the pen 100 or the like (the locus of “Λ”-shape and the locus of “-”-shape).

To be more specific, while the pen 100 is being moved, the locus of “Λ”-shape of the pen 100 is sampled in real time. Thereby, a plurality of point data (coordinate data) PD11, PD12, . . . PD1m corresponding to a plurality of points on the “Λ” locus of the pen 100 is subsequently obtained. For example, each time the pen 100 on the screen is moved by a predetermined distance, point data indicating a new position may be obtained. Although in order that FIG. 7 be simplified, the density of point data is represented at a low density, actually, point data are obtained at more high density. The point data PD11, PD12, . . . PD1m are used in drawing, on the screen, a line corresponding to the “Λ” locus of the pen 100. The line corresponding to the “Λ” locus of the pen 100 is drawn in real time on the screen in such a way as to follow the movement of the pen 100.

Similarly, while the pen 100 is being moved, the locus of “-”-shape of the pen 100 is sampled in real time. Thereby, a plurality of point data (coordinate data) PD21, PD22, . . . PD2n corresponding to a plurality of points on the “-” locus of the pen 100 is subsequently obtained.

The handwritten character “B” is formed by two strokes input by handwriting with the pen 100 or the like. The handwritten character “C” is formed by a single stroke input by handwriting with the pen 100 or the like.

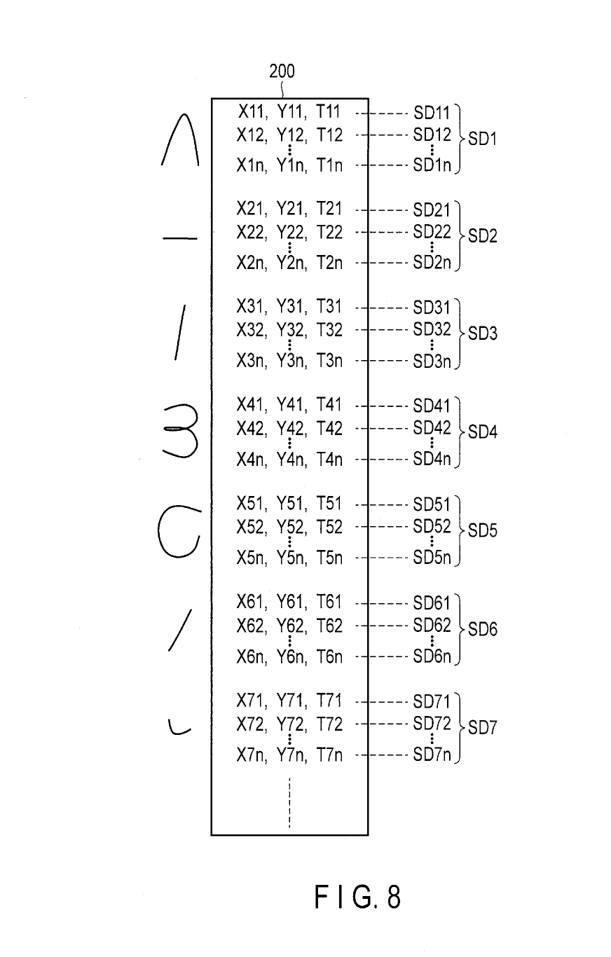

FIG. 8 shows time-series information 200 corresponding to the handwritten character string as shown in FIG. 7. The time-series information 200 includes plural stroke data SD1, SD2, . . . SD7. In the time-series information 200, the stroke data SD1, SD2, . . . SD7 are arranged in the order of making strokes, i.e., in the order in which strokes corresponding to the stroke data are input by handwriting.

In the time-series information 200, the first two stroke data, i.e., the stroke data SD1 and SD2, indicate two strokes forming the handwritten character “A”. Third and fourth stroke data SD3 and SD4 indicate two strokes forming the handwritten character “B”. Fifth stroke data SD5 indicates a single stroke forming the handwritten character “C”. Sixth and seventh stroke data SD6 and SD7 indicate two strokes given to form a handwritten arrow.

Each of the stroke data includes coordinates corresponding to a plurality of points on the locus of an associated single stroke. In each stroke data, the points corresponding to the coordinates are located in the order of making the stroke. For example, with respect to the handwritten character “A”, the stroke data SD1 includes coordinate data series (time-series coordinates) corresponding to points on the locus of the “Λ” stroke of the strokes forming the handwritten character “A”, i.e., n coordinate data SD11, SD12, . . . SD1n. The stroke data SD2 includes coordinate data series corresponding to points on the locus of the “-” stroke of the strokes forming the handwritten character “A”, i.e., n coordinate data SD21, SD22, . . . SD2n. It should be noted that the number of coordinate data may vary from one stroke data to another.

Each of coordinate data indicates the X coordinate and Y coordinate of a corresponding point on an associated locus. For example, the coordinate data SD11 indicates the X coordinate (X11) and Y coordinate (Y11) of a starting point of the “Λ” stroke. The coordinate data SD1n indicates the X coordinate (X1n) and Y coordinate (Y1n) of an ending point of the “Λ” stroke.

Furthermore, each coordinate data may include time stamp information T regarding the point of time at which a point whose coordinates are indicated by each coordinate data was handwritten. The above point of time may be indicated as either absolute time (for example, year, month, day, hour, minute and second) or relative time with respect to a given point of time. For example, it may be set that absolute time of starting to write a stroke (e.g., year, month, day, hour, minute and second) is added as time stamp information, and in addition, to each coordinate data in stroke data, relative time indicating the difference between a point of time and absolute time is added as stamp information T.

Also, to each coordinate data, information (Z) indicating a writing pressure may be added.

Next, some features of the handwriting collaboration function in the embodiment will be explained.

As described above, the handwriting collaboration function enables a plurality of users to perform handwriting on the same canvas at the same time.

On the shared canvas, since a plurality of persons handwrite respective strokes, there is a case where when content displayed on the canvas is viewed later, with respect to each of the strokes, it cannot be easily determine which of the persons handwrites which of strokes.

In the embodiment, the handwriting collaboration function can cause each of strokes, which users input by handwriting, to be displayed in such a way as to distinguishably indicate which user inputs which stroke by handwriting, since the strokes are drawn in different colors, which are assigned to the users, respectively. By virtue of this feature, when viewing the contents displayed on the canvas, with respect to each of the strokes, each of the users can know which of them draws each stroke.

Instead of assigning different colors to strokes to be input by the users, respectively, or in addition to this assignment, the settings for the users may be changed in at least one of the width of a stroke, the type of a pen (pencil, ballpoint pen, a fountain pen or the like) and the degree of transparency. That is, the handwriting collaboration function can cause, for example, stroke data received from the participator B and stroke data received from the participator C to be displayed in different style (e.g., different colors, different widths, different pen types or different degrees of transparence), based on information for assigning different display styles to a plurality of participators.

The handwriting collaboration function can make a style control function operative or inoperative, the style control function being provided as a function for changing display styles set for persons.

The handwriting collaboration function can also cause strokes input by participators to be displayed in manners (colors, widths, kinds of pens or degrees of transparency) which are set by the participators, respectively. To stroke data received from the terminals of the participators, attribute information may be added. If the function for changing the display styles set for persons is inoperative, the handwriting collaboration function can cause each of the received stroke data to be displayed in a style specified by attribute information added to each of the received stroke data. Thereafter, the style control function for changing the display styles set for persons is made operative, the handwriting collaboration function changes the display style in which each stroke data is displayed to a style assigned to a participator who inputs a corresponding stroke by handwriting.

The handwriting collaboration function can cause a user interface to be displayed, the user interface being used in selecting a participator whose stroke is to be displayed. Also, the handwriting collaboration function can cause a stroke input by a participator not selected to be undisplayed temporarily. Thus, each participator can cause only a stroke of a user to be noticed to be displayed on the screen of his or her terminal, as occasion demands.

Based on a relationship between times when strokes were input by handwriting by same participator, the handwriting collaboration function can change the display colors of these strokes. Also, based on the above relationship, the widths of the strokes and pen types the strokes may be changed in addition to the display colors. To be more specific, with respect to strokes input by handwriting by the same participator, the handwriting collaboration function causes one or more stroke data input by handwriting in a first time period and one or more stroke data input by handwriting in a second time period subsequent to the first time period to be displayed in different styles. As the second time period, a time period corresponding to the present time may be applied. In this case, one or more stroke data input by handwriting in the second time period is one or more newest stroke data input by handwriting.

For example, the handwriting collaboration function may classify strokes input by handwriting by the same participator into a newest stroke, a relatively new stroke and an old stroke, and cause the newest, relatively new stroke and old stroke to be displayed in different styles (e.g., different colors, different widths or different pen types). Suppose red is assigned to a given participator. In this case, the newest stroke input by the participator may be displayed in very bright red (highlighted). The second-newest stroke input by the participator may be displayed in bright red. The other stroke or strokes input by the participator, i.e., an old stroke or strokes input by the participator, may be displayed in normal red. This feature can cause the user to easily note a new stroke.

The handwriting collaboration function can manage connection states of participators. The connection states are states regarding connections between the electronic device (server) 10A and the participators (terminals). The connection states, for example, include a login state in which a participator (terminal) logs in to the handwriting sharing service (group), a logout state in which a participator (terminal) logs out from the handwriting sharing service (group), etc. Alternatively, the connection states, for example, may include an intermediate state, e.g., a state in which a participator temporarily leaves from his or her seat.

The handwriting collaboration function can change the display style (color, width, pen type or degree of transparency) of each participator in accordance with the present connection state of each participator.

For example, if a participator, who is in the login state, logs out, the display color of each of strokes input by the participator may be changed from a present display color (e.g., color assigned to the participator) to an undistinguished color, e.g., gray. Thereby, each of strokes on the canvas can be displayed such that it can be determined whether each stroke is a stroke input by a user participating in the handwriting sharing service or a stroke input by a user logging out from the handwriting sharing service.

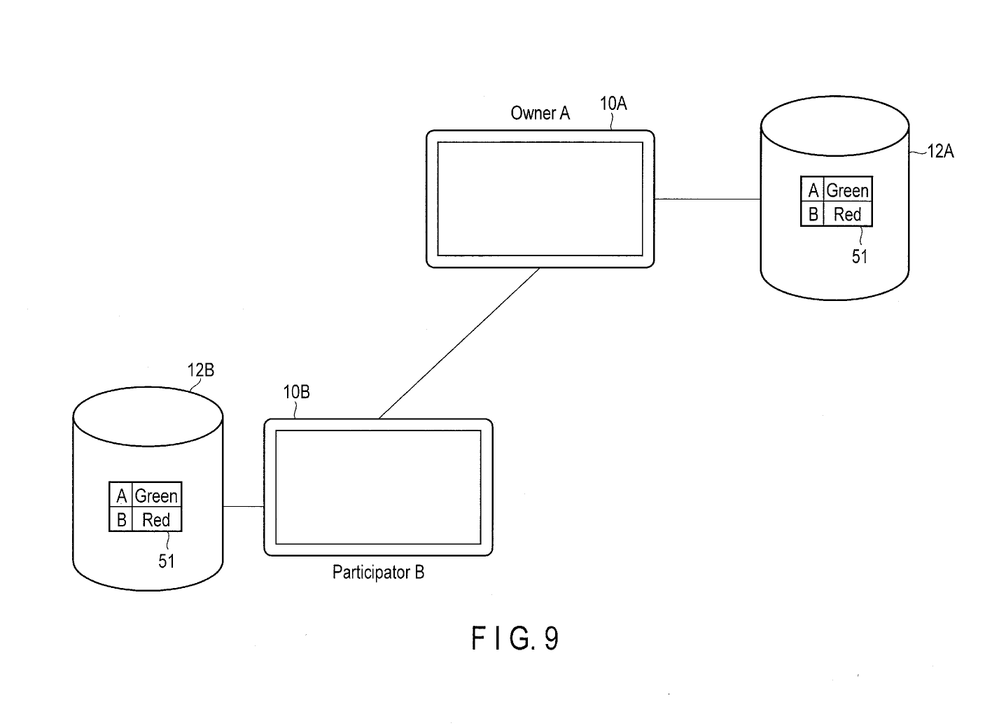

FIG. 9 shows a process in which different display styles are assigned to a plurality of users.

FIG. 9 shows the case where the owner A and the participator B participate in the handwriting sharing service (group). The electronic device 10A assigns different display styles to strokes input by the owner A and the participator B, to thereby prepare a display style list 51 indicating the display styles assigned to the owner A and the participator B. The display style list 51 is stored in a database 12A for the electronic device 10A. Furthermore, the display style list 51 is transmitted from the electronic device 10 to the electronic device 10B of the participator B. It is then stored in a database 12B for the electronic device 10B.

FIG. 9 shows the case where “green” and “red” are assigned to the owner A and the participator B, respectively.

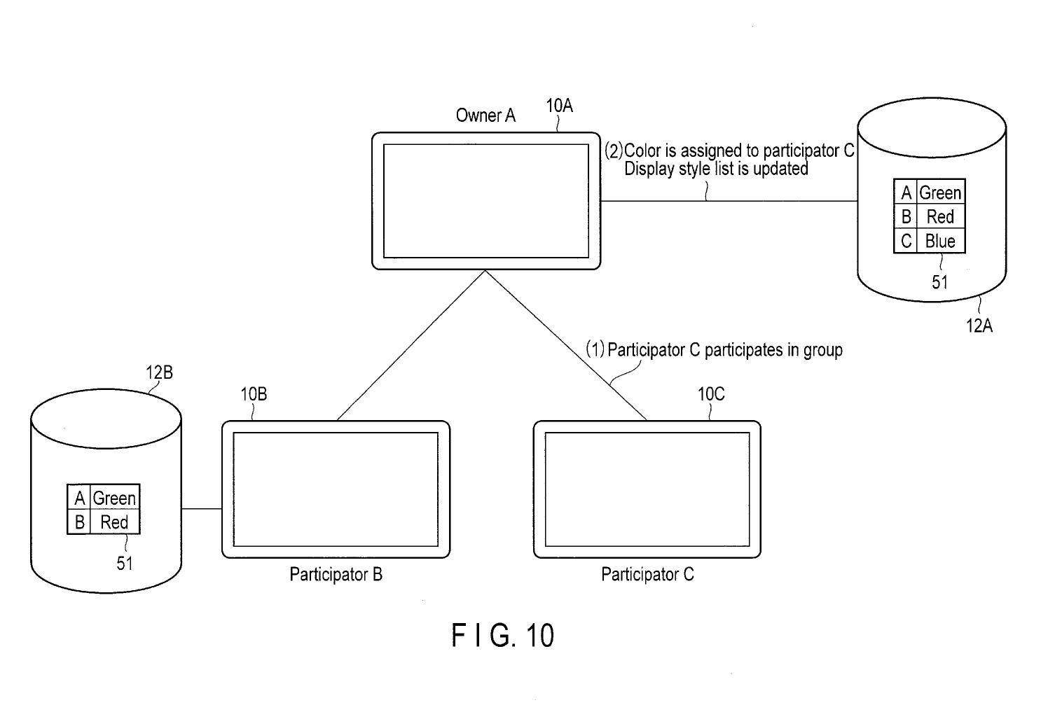

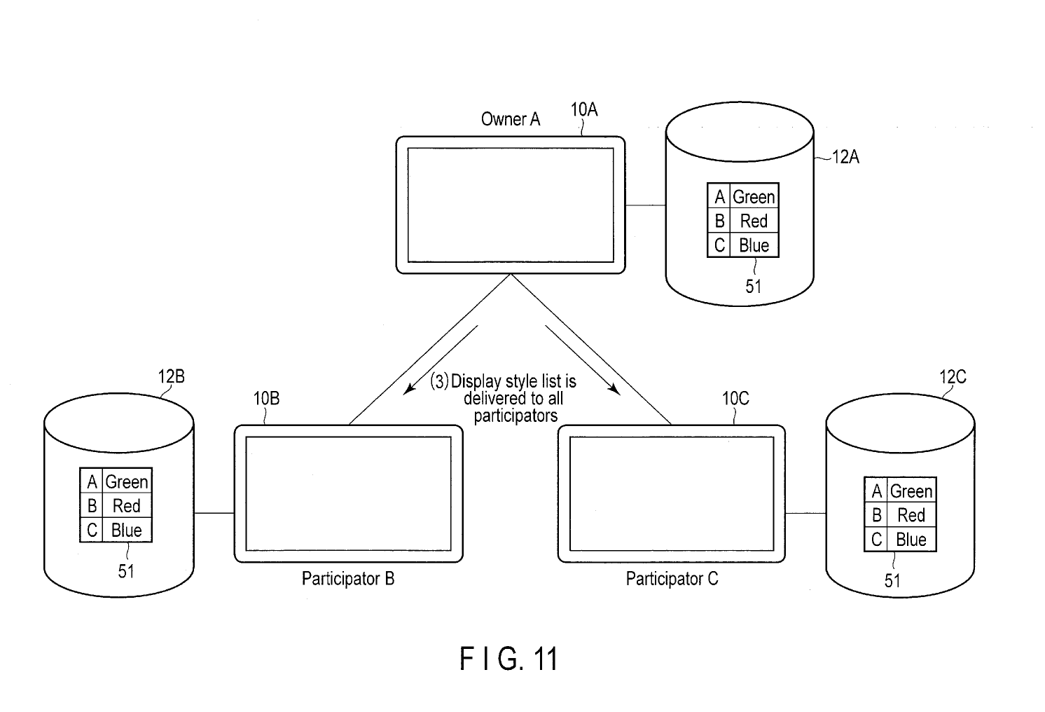

Next, a process for updating the display style list 51 will be explained with reference to FIGS. 10 and 11.

(1) As shown in FIG. 10, the electronic device 10C of the participator C newly participates in (logs in to) the handwriting sharing service (group).

(2) As shown in FIG. 10, the electronic device 10A assigns a color, e.g., “blue”, which is different from colors assigned to other participators (corresponding to the owner A and the participator B in this case), to the participator C. Then, the electronic device 10A updates the display style list 51 in the database 12A to add information indicating that “blue” is assigned to the participator C to the display style list 51.

(3) As shown in FIG. 11, the electronic device 10A delivers the updated display style list 51 to all the participators. The updated display style list 51 is stored in the database 12B for the electronic device 10B (that is, the display style list 51 stored in the database 12B is overwritten with the updated display style list 51). Furthermore, the updated display style list 51 is also stored in the database 12C for the electronic device 10C.

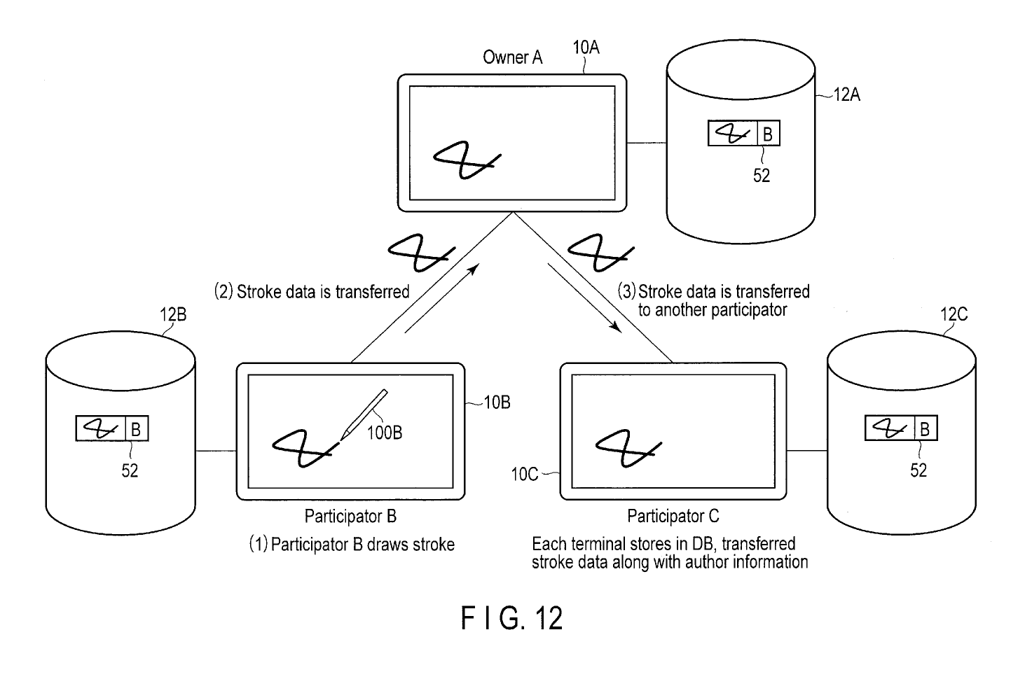

Next, an operation for sharing handwriting data (stroke data) will be explained with reference FIG. 12.

(1) In the electronic device 10B, the participator B inputs a stroke by handwriting with the pen 100B. The stroke is drawn on the canvas of the electronic device 10B. Stroke data corresponding to the stroke is stored along with writer information (also referred to as author information) indicating the participator B, in a stroke database 52 in the database 12B. As the writer information, arbitrary information which enables a user inputting the stroke data by handwriting to be identified can be applied. For example, as the writer information, a device ID of the electronic device 10B may be applied, or a user ID of the user B may be applied.

(2) The electronic device 10B transmits to the electronic device 10A, the stroke data corresponding to the stroke along with the writer information. The electronic device 10A receives the stroke data and the writer information. The received stroke data is stored along with the writer information indicating the participator B in a stroke database 52 in the database 12A. The stroke data is drawn on the canvas of the electronic device 10A.

(3) The electronic device 10A transmits to the electronic device 10C, the received stroke data along with the writer information indicating the participator B. The electronic device 10C receives the stroke data and the writer information from the electronic device 10A. The received stroke data is stored along with the writer information indicating the participator B in a stroke database 52 in the database 12C. Then, the received stroke data is drawn on the canvas of the electronic device 10C.

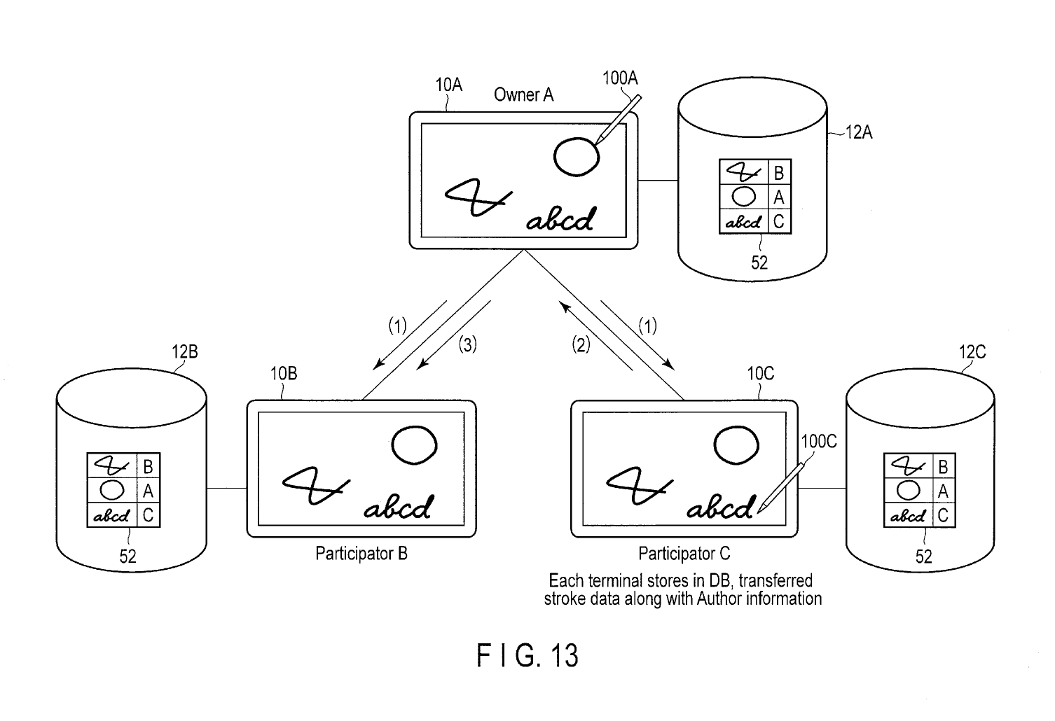

Next, a process to be executed in the case where a stroke is input by handwriting in the electronic device 10A and a process to be executed in the case where a stroke is input by handwriting in the electronic device 10C will be explained with reference to FIG. 13.

(1) In the electronic device 10A, a stroke is input by handwriting with the pen 100A by the owner A. The stroke data is drawn on the canvas of the electronic device 10A. Stroke data corresponding to the stroke is added along with writer information indicating the owner A to the stroke database 52 in the database 12A. The electronic device 10A transmits the stroke data along with the writer information indicating the owner A to both the electronic device 10B of the participator B and the electronic device 10C of the participator C.

In the electronic device 10B, the stroke data and the writer information indicating the owner A are added to the stroke database 52 in the database 12B. Then, the stroke data is drawn on the canvas of the electronic device 10B.

In the electronic device 10C, the stroke data and the writer information indicating the owner A are added to the stroke database 52 in the database 12C. Then, the stroke data is drawn on the canvas of the electronic device 10C.

(2) In the electronic device 10C, the participator C inputs a stroke by handwriting with the pen 100C. The stroke is drawn on the canvas of the electronic device 10C. Stroke data corresponding to the stroke is stored along with writer information indicating the participator C in the stroke database 52 in the database 12C. The electronic device 10C transmits the stroke data corresponding to the stroke along with the writer information to the electronic device 10A. The electronic device 10A receives the stroke data and the writer information from the electronic device 10C. The received stroke data is added along with the writer information indicating the participator C to the stroke database 52 in the database 12A. The received stroke data is drawn on the canvas of the electronic device 10A.

(3) The electronic device 10A transmits the received stroke data along with the writer information indicating the participator C to the electronic device 10B. The electronic device 10B receives the stroke data and the writer information from the electronic device 10A. In the electronic device 10B, the received stroke data is added along with the writer information indicating the participator C to the stroke database 52 in the database 12B. Then, the stroke data is drawn on the canvas of the electronic device 10B.

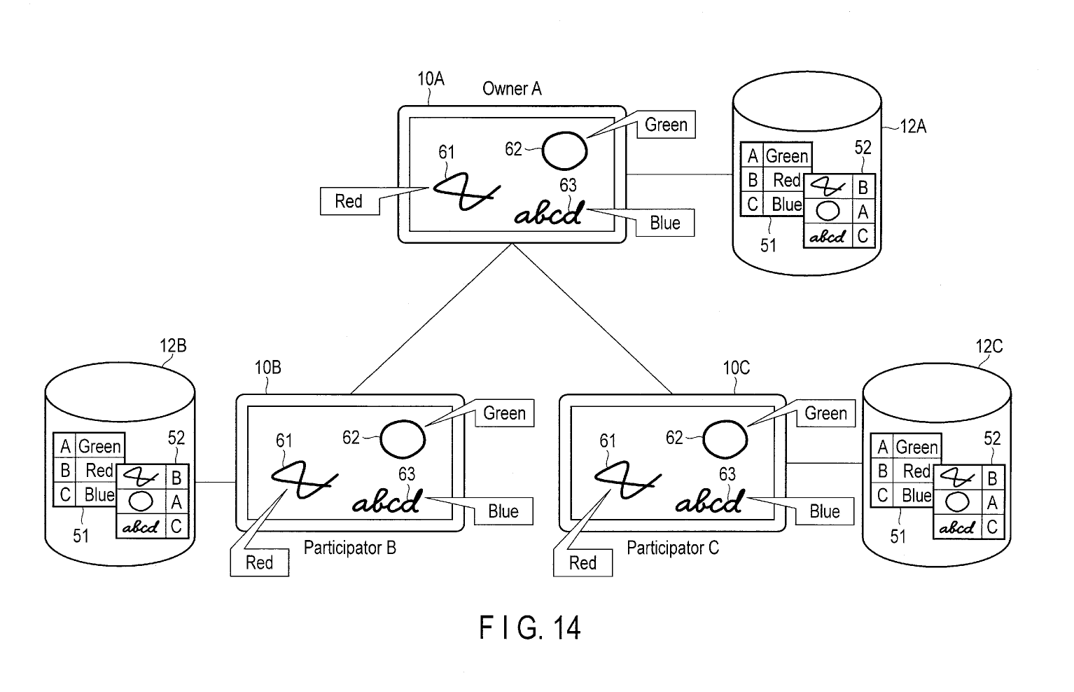

FIG. 14 shows a process in which strokes input by the owner A, the participator B and the participator C are displayed in different styles.

Each of the electronic device 10A, the electronic device 10B and the electronic device 10C holds the display style list 51. Furthermore, the electronic device 10A, the electronic device 10B and the electronic device 10C holds a plurality of stroke data to each of which writer information is associated. Therefore, the electronic device 10A, the electronic device 10B and the electronic device 10C display stroke data 61 of the participator B in red, stroke data 62 of the owner A in green and stroke data 63 of the participator C in blue.

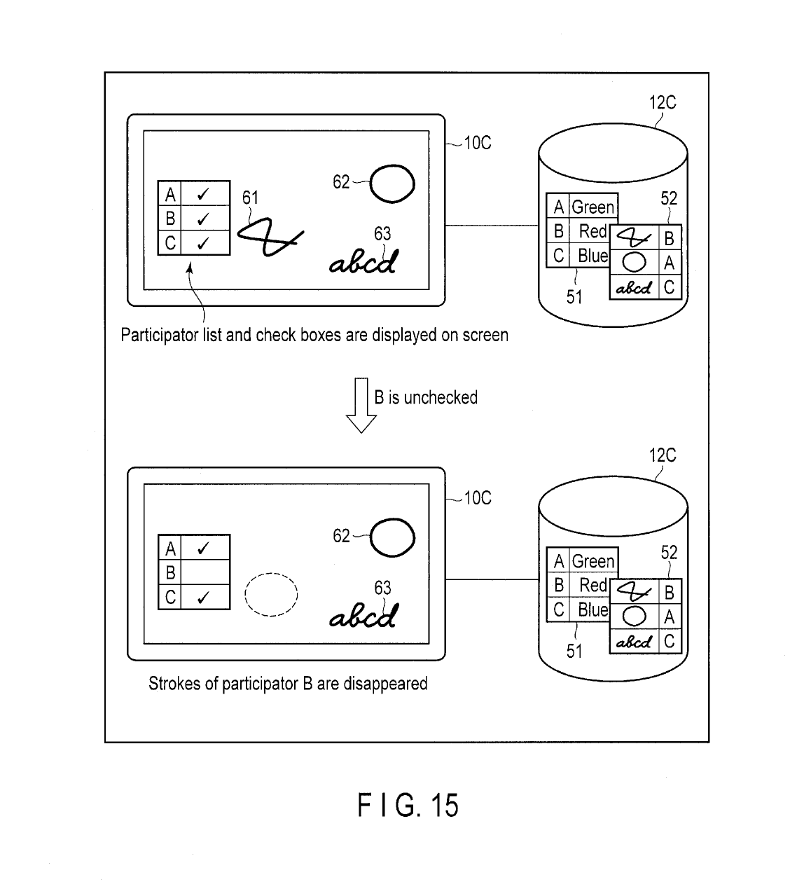

Next, a process (filtering) for displaying strokes of the only selected participator or participators by using a participator list and a check box will be explained with reference to FIG. 15.

FIG. 15 shows the case where filtering is executed in the electronic device 10C.

In accordance with an operation by the participator C, the electronic device 10C displays the participator list and check boxes on the canvas of the electronic device 10C. The participator list and the check boxes are used as a user interface which can select a user (participator) whose stroke data is to be displayed.

In the participator list, the users A, B and C are indicated. In a default state, all check boxes associated with all users may be checked. The participator C can uncheck the box for an arbitrary user, as occasion demands. If the participator C uncheck the box for the user B, i.e., the users A and C are selected, and the user B is not selected, the electronic device 10C refers to the stroke database 52 in the database 12C, and specifies stroke data regarding the user B not selected. Then, the electronic device 10C makes the stoke data regarding the user B undisplayed.

Since the stroke data 61 of the participator B (the user B), the stroke data 62 of the owner A (the user A) and the stroke data 63 of the participator C (the user C) are displayed on the canvas of the electronic device 10C, only the stroke data 61 is made undisplayed, and disappeared from the canvas of the electronic device 10C. In the stroke database in the database 12C, the stroke data 61 is maintained. Thus, if the participator C checks the check box for the user B later, the stroke data of the user B can be re-displayed on the canvas of the electronic device 10C. If the electronic device 10C receives new stroke data of the participator B (the user B) from the electronic device 10A, with the check box for the user B unchecked, the new stroke data may be added along with the writer information indicating the participator B to the stroke database 52 in the database 12C. By virtue of this structure, the participator C can view the stroke data regarding the participator B at an arbitrary timing, as occasion demands.

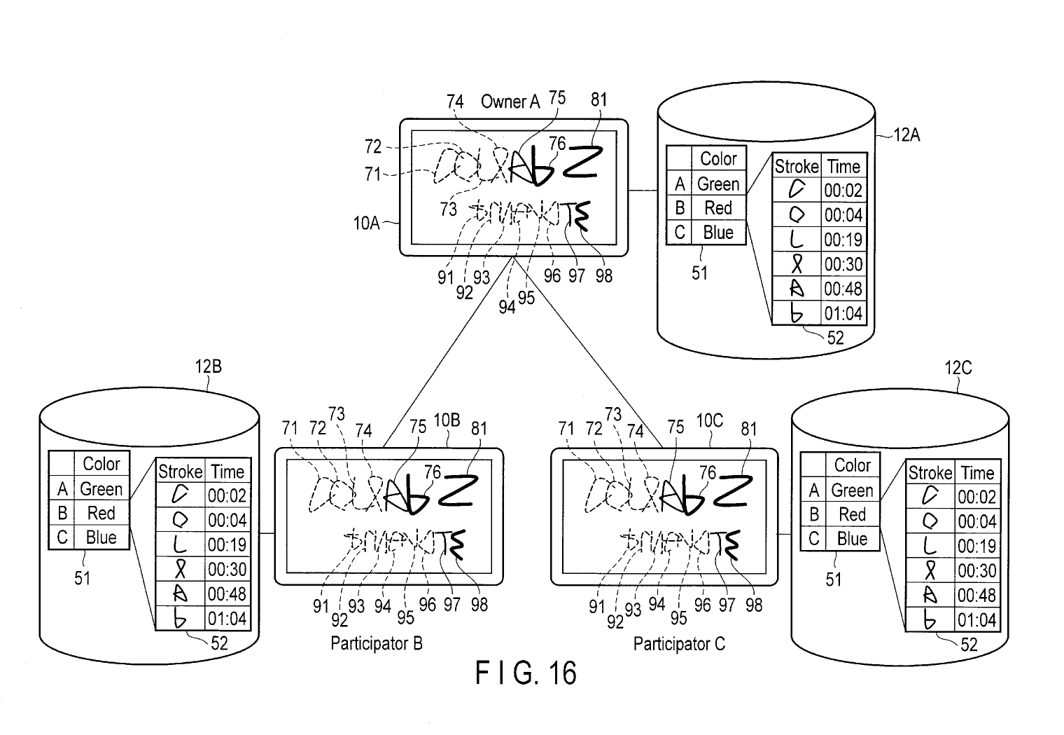

Next, a process in which a plurality of strokes input by handwriting by the same participator are displayed in some different manners will be explained with reference to FIG. 16.

The electronic device 10A stores stroke data received from the terminals of participators, along with time information indicating times at which their strokes were input by handwriting, in the stroke database 52 in the database 12A. As the time information, time (hour, second, minute) at which the electronic device 10A received the stroke data may be applied. Alternatively, each of the terminals of the participators may add time information indicating time at which stroke data was input at each terminal to the stroke data, and transmit the stroke data to which the time information is added to the electronic device 10A.

Also, with respect to stroke data corresponding to a stroke input by handwriting at the electronic device 10A, the electronic device 10A stores the stroke data along with time information indicating time at which it was input by handwriting, in the stroke database 52 in the database 12A. Furthermore, the electronic device 10A transfers the stroke data to which the time information is added to the terminals.

Therefore, in each of all the stroke databases 52 for the terminals, time information is added to each of the stroke data.

Suppose the participator B inputs strokes 71-76 by handwriting in this order, and the strokes 71-76 are displayed on the canvases of the terminals.

Of the strokes 71-76, the stroke 76 is the newest stroke, which was input by handwriting latest. In this case, the stroke 76 may be highlighted. For example, since red is assigned to the participator B, the stroke 76 may be displayed in very bright red (referring to FIG. 16, strokes having a very bright color are bold). The stroke 75 is the second-newest stroke, and may thus be displayed in bright red (referring to FIG. 16, strokes having a bright color are indicated by solid lines). The other strokes, i.e., the strokes 71-74 may be displayed in normal red (referring to FIG. 16, strokes having a normal color are indicated by broken lines).

If the participator B further inputs a new stroke by handwriting, the new stroke is displayed in very bright red. Then, the color of the stroke 76 is changed from very bright red to bright red.

Referring to FIG. 16, a stroke 81 is a stroke input by handwriting by the owner A. If only the stroke 81 is input by handwriting by the owner A, the stroke 81 is highlighted. For example, since green is assigned to the owner A, the stroke 81 may be displayed in very bright green.

Referring to FIG. 16, strokes 91-98 are strokes input by handwriting by the participator C. Of the strokes 91-98, the stroke 98 is the newest stroke, which was input by handwriting latest. In this case, the stroke 98 may be highlighted. For example, since blue is assigned to the participator C, the stroke 98 may be displayed in very bright blue. Since the stroke 97 is the second-newest stroke, it may be displayed in bright blue. The other strokes, i.e., the strokes 91-96, may be displayed in normal blue.

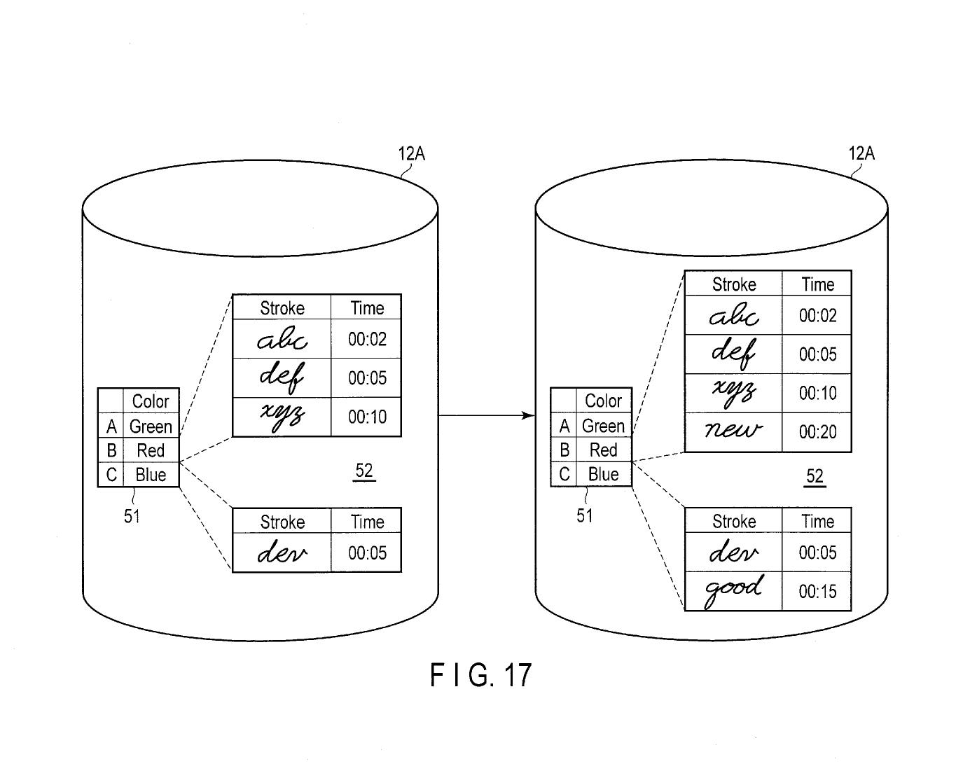

FIG. 17 shows by way example times at which strokes were input by handwriting by the participator B and times at which strokes were input by handwriting by the participator C.

The participator B inputs by handwriting a stroke corresponding to the handwritten cursive character string “abc”, a stroke corresponding to the handwritten cursive character string “def” and a stroke corresponding to the handwritten cursive character string “xyz” in this order. Then, the participator B further inputs by handwriting a stroke corresponding to the handwritten cursive character string “new”. The participator C inputs by handwriting a stroke corresponding to the handwritten cursive character string “dev”. Thereafter, the participator C further inputs by handwriting a stroke corresponding to the character string “good”.

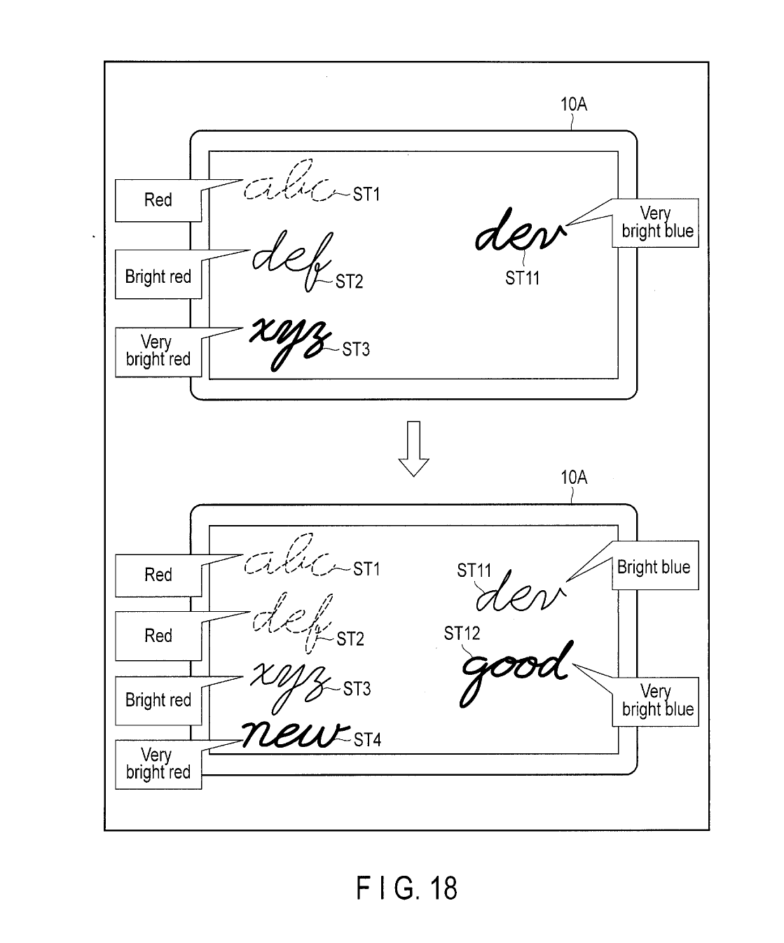

Upper part of FIG. 18 shows a state of the canvas of the electronic device 10A just after the cursive character string “xyz” have been input by handwriting.

A stroke ST1 corresponds to the cursive character string “abc” input by handwriting by the participator B, a stroke ST2 corresponds to the cursive character string “def” input by handwriting by the participator B, and a stroke ST3 corresponds to the cursive character string “xyz” input by handwriting by the participator B. Furthermore, a stroke ST11 corresponds to the cursive character string “dev” input by handwriting by the participator C.

Of the strokes ST1-ST3, the stroke ST3 is displayed in very bright red. The stroke ST2 is displayed in bright red. The stroke ST1 is displayed in normal red.

The stroke ST11 is displayed in very bright blue.

Lower part of FIG. 18 shows a state of the electronic device 10A just after the cursive character strings “good” and “new” have been input by handwriting.

The stroke ST4 corresponds to the cursive character string “new” handwriting by the participator B. Of the strokes ST1-ST4, the stroke ST4 is displayed in very bright red. The display color of the stroke ST3 is changed from very bright red to bright red. Then, the strokes ST1 and ST2 are displayed in normal red.

A stroke ST12 corresponds to the cursive character string “good” input by handwriting by the participator C. Of the strokes ST11 and ST12, the stroke ST12 is displayed in very bright blue. The display color of the stroke ST11 is changed from very bright blue to bright blue.

It should be noted that although referring to FIGS. 16-18, of a plurality of strokes input by the same participator, only one stroke is highlighted, some last strokes may be highlighted. For example, a predetermined number of last strokes may be classified as strokes of a newest stroke group. Also, the predetermined number of strokes input just before the strokes of the newest stroke group may be classified as strokes of a new stroke group. Furthermore, all the remaining strokes, which were input before the strokes of the new stroke group, may be classified as strokes of an old stroke group.

Needless to say, the number of groups may be larger than 3.

Alternatively, instead of the time information which is added to the stroke data, the order in which the stroke data are received may be applied to classify the stroke data into the newest stroke group, the new stroke group and the old stroke group.

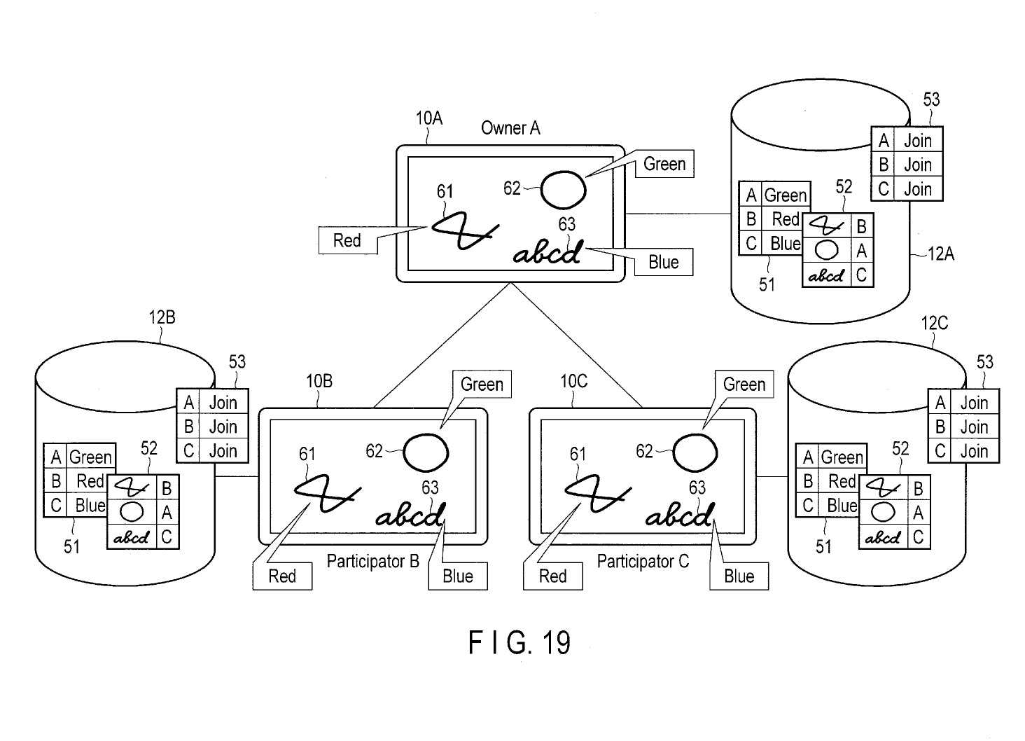

FIG. 19 shows a process for managing connection states of participators.

The electronic device 10A manages the connection states of the user A, the user B and the user C, and generates a connection status list 53 indicating the connection states of the user A, the user B and the user C. If the electronic devices 10A, 10B and 10C log in to the handwriting sharing service, in the connection status list 53, the connection states of the user A, the user B and the user C are set to “Join”. “Join” indicates that the present connection state is the login state.

The electronic device 10A delivers the connection status list 53 to the electronic devices 10B and 10C. As a result, the connection status list 53 is stored in the database 12B for the electronic device 10B, and also stored in the database 12C for the electronic device 10C.

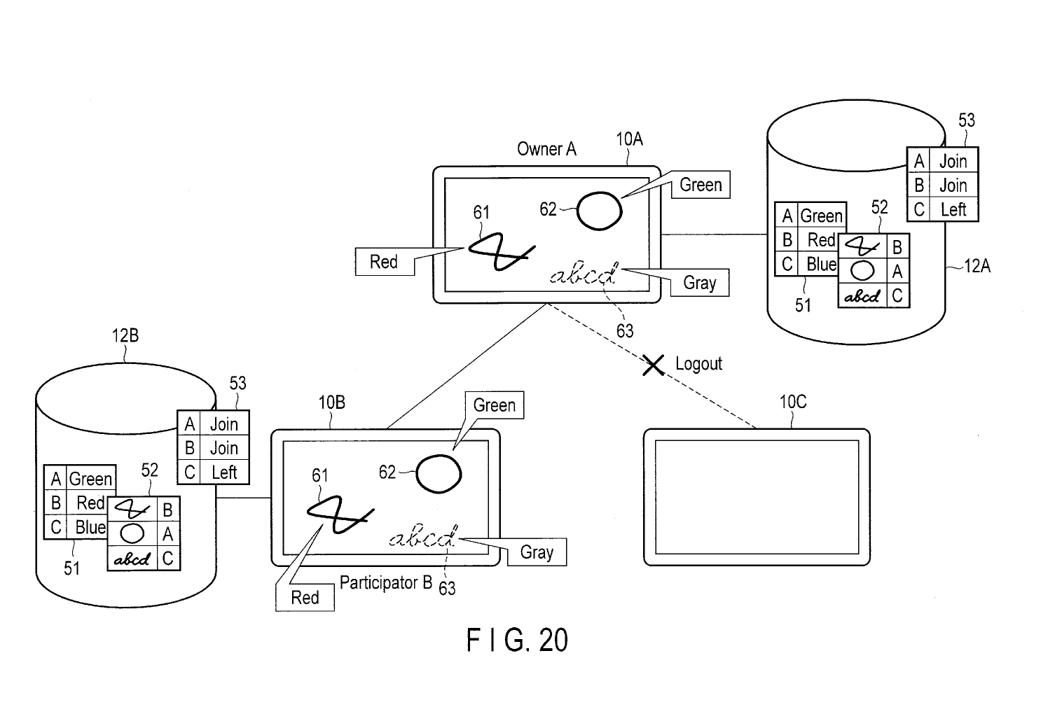

FIG. 20 shows a process for changing display styles of strokes input by the participators in accordance with the present connection states of the participators.

The following explanation is given with respect to the case where the connection state of the electronic device 10C is changed from the login state to the logout state. The electronic device 10C is made to log out, by occurrence of an event, for example, exiting from a handwriting sharing application program in the electronic device 10C, an explicit logout operation by the participator C or powering off of the electronic device 10C.

When the electronic device 10A detects that the participator C (the electronic device 10C) logs out, the electronic device 10A updates the connection status list 53, and changes the connection state of the participator C to “Left”, which indicates the logout state. Then, the electronic device 10A refers to the stroke database 52 in the database 12A, specifies stroke data of the participator C, and changes the display style of the stroke data to an undistinguished display style. The display color of the stroke data 63 regarding the participator C, which is displayed in blue, is changed to, e.g., gray, after the participator C logs out.

The electronic device 10A delivers the updated connection status list 53 to the electronic device 10B. The updated connection status list 53 is stored in the database 12B for the electronic device 10B (that is, the updated connection status list 53 stored in the database 12B is overwritten with the updated connection status list 53).

Also, the electronic device 10B refers to the stroke database 52 in the database 12B, specifies stroke data of the participator C, and changes the display style of the stroke data, e.g., changes the color thereof to gray.

In such a manner, in the embodiment, in accordance with the present connection states of participators, the display styles of strokes input by the participators are automatically changed. Therefore, strokes on the canvas can be distinguishably displayed such that it can be determined whether each of the strokes is a stroke input by a participator logging in to the handwriting sharing service or a stroke input by a participator logging out from the handwriting sharing service.

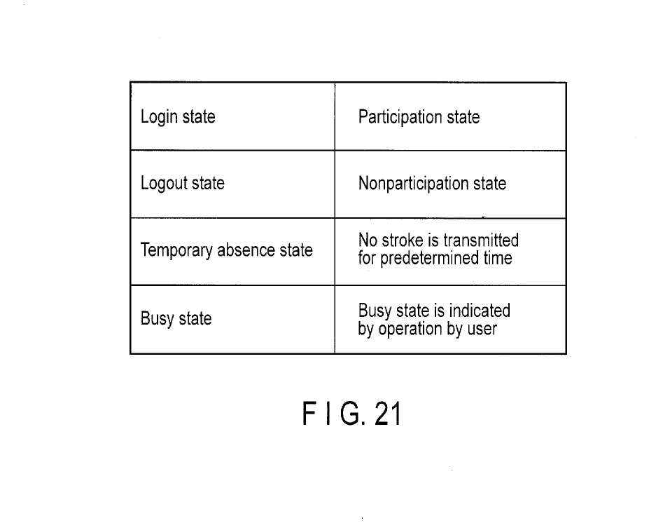

FIG. 21 shows an example of the connection states of participators.

The connection states are states of connections between terminals (the electronic devices 10B and 10C, which function as clients of the participators) and the handwriting sharing service (the electronic device 10A, which functions as a server). The connection state can include the login state and at least one or more states other than the login state. The login state is a state in which a terminal participates in the handwriting sharing service, i.e., a state in which a connection between the terminal and the electronic device 10A is established. The above one or more states include, for example, the logout state, a temporary absence state, a busy state, etc. The logout state is a state in which the terminal does not participate in the handwriting sharing service, i.e., the connection between the terminal and the electronic device 10A is not established. The temporary absence state and the busy state are intermediate between the login state and the logout state. For example, in a situation in business such as a conference, there is a case where a participator temporarily leaves in the middle of a conference (the handwriting sharing service) in order to cope with a rush job coming in. Such a state in which the participator temporarily leaves in the middle of a conference corresponds to the temporary absence state or the busy sate.

As a method of detecting a state which a participator temporarily leaves in the middle of a conference, a method of determining whether time for which transmission of stroke data from the terminal to the electronic device 10A is stopped is predetermined time or more can be applied. Alternatively, by an explicit operation by a participator, the terminal may be made to notify the electronic device 10A that the participator temporarily leaves in the middle of a conference. The present connection state of the terminal which is determined by the above former method as a state in which the participator temporarily leaves in the middle of the conference may be handled as the temporal absence state. The present connection state of the terminal which is determined by the above latter method as a state in which the participator temporarily leaves in the middle of the conference may be handled as the busy state.

When the present connection state of a participator is changed from the login state to any of the logout state, the temporary absence state and the busy state, the color of strokes input by the participator may be changed from their present color to gray. That is, when the present connection state of the participator is changed from the login state to any of the states other than the login state, the display style of the strokes input by the participator is changed.

Alternatively, four display styles associated with the login state, the logout state, the temporary absence state and the busy state may be determined in advance. In this case, in accordance with the present connection state of the participator, the display style of the strokes input by the participator is changed between the four displayer styles.

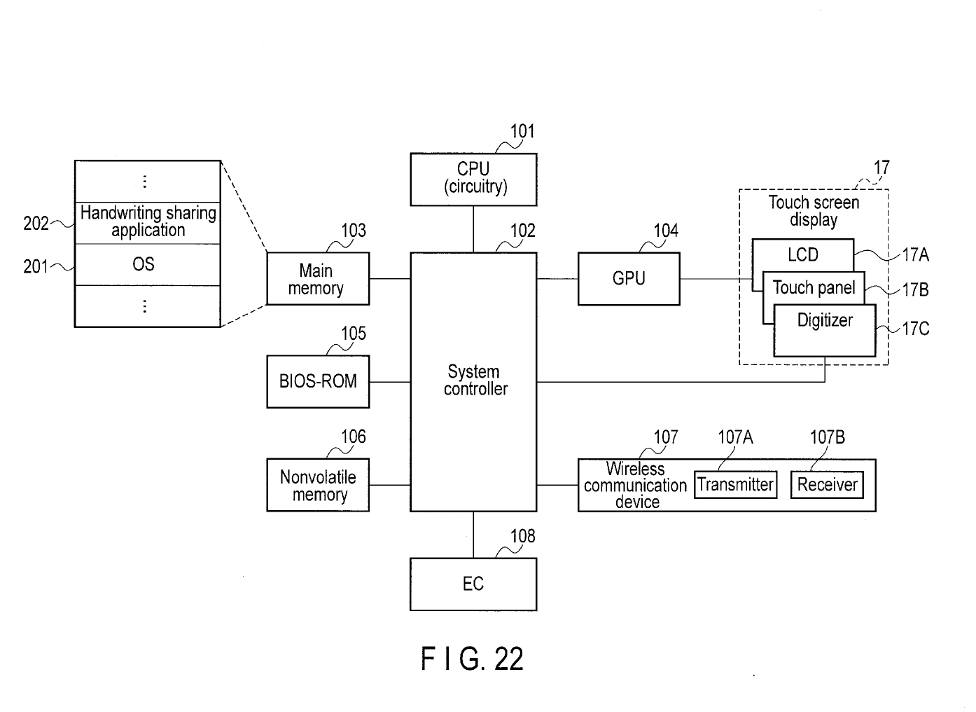

FIG. 22 is a system configuration of the tablet computer 10.

The tablet computer 10 comprises a CPU 101, a system controller 102, a main memory 103, a graphics processing unit (GPU) 104, a BIOS-ROM 105, a nonvolatile memory 106, a wireless communication device 107, an embedded controller (EC) 108, etc.

The CPU 101 is a processor which controls operations of various components in the tablet computer 10. The processor includes circuitry (process circuitry). The CPU 101 executes various programs loaded from the nonvolatile memory 106, which is a storage device, into the main memory 103. Those programs include an operating system (OS) 201 and various application programs. The application programs include a handwriting sharing application program 202. The handwriting sharing application program 202 can perform the above handwriting collaboration function for causing handwritten information to be shared among a plurality of electronic devices.

Furthermore, the CPU 101 also executes a basic input output system (BIOS) stored in the BIOS-ROM 105. The BIOS is a program for controlling hardware.

The system controller 102 is a device which connects a local bus of the CPU 101 and various components. The system controller 102 incorporates a memory controller which controls an access to the main memory 103. Also, the system controller 102 has a function of executing communication with the graphics process unit (GPU) 104 through a serial bus or the like conforming to PCI EXPRESS standards.

The GPU 104 is a display processor (display control circuit) which controls an LCD 17A used as a display monitor of the tablet computer 10. A display signal produced by the GPU 104 is sent to the LCD 17A. The LCD 17A displays a screen image based on the display signal. On an upper surface side of the LCD 17A, a touch panel 17B is provided. On a lower surface side of the LCD 17A, a digitizer 17C is provided. The touch panel 17B is a capacitance type pointing device for performing inputting on a screen of the LCD 17A. The position, movement, etc. of a finger contacting the screen are detected by the touch panel 17B. The digitizer 17C is an electromagnetic induction type pointing device for performing inputting on the screen of the LCD 17A. The position, movement, etc. of the pen 100 contacting the screen are detected by the digitizer 17C.

The wireless communication device 107 is a device configured to execute wireless communication. The wireless communication device 107 includes a transmitter 107A which wirelessly transmits a signal and a receiver 107B which wirelessly receives a signal. The EC 108 is a one-chip microcomputer including an embedded controller for power management. The EC 108 has a function of powering on or off the tablet computer 10 in accordance with an operation on a power button by the user.

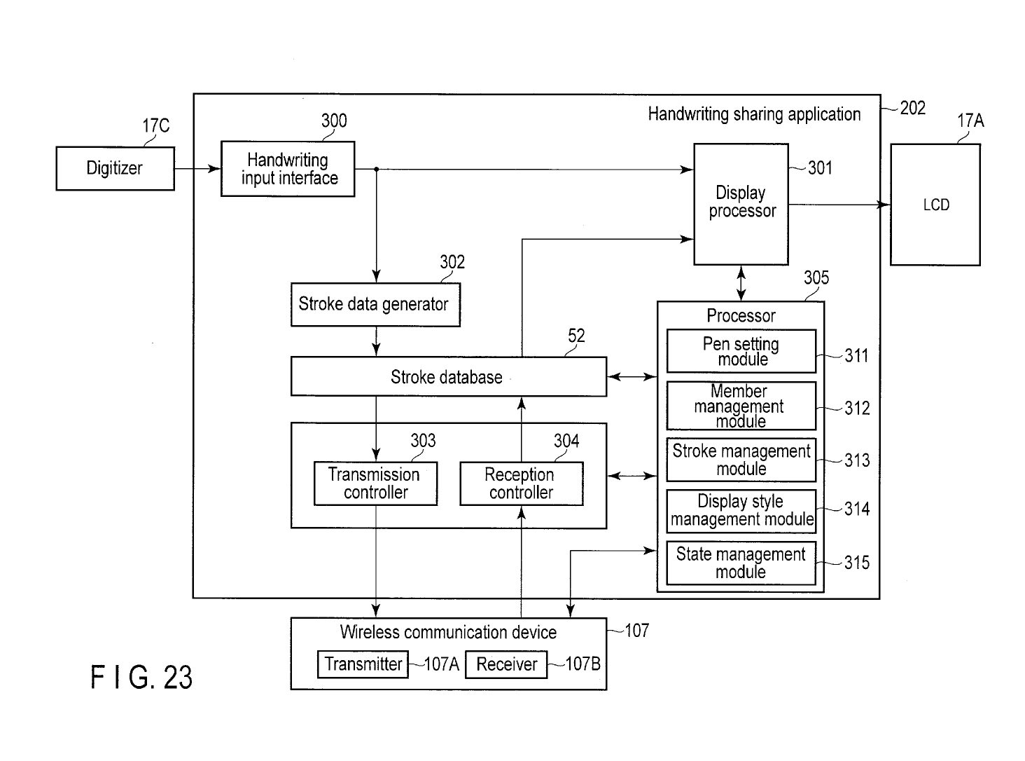

Next, a configuration of the handwriting sharing application program 202 will be explained with reference to FIG. 23.

The handwriting sharing application program 202 includes as function execution modules for sharing handwritten information, a handwriting input interface 300, a display processor 301, stroke data generator 302, a transmission controller 303, a reception controller 304, a processor 305, etc.

The handwriting sharing application program 202 creates, displays and edits handwriting page data, using stroke data input with the touch screen display 17. The digitizer 17c of the touch screen display 17 is configured to detect an occurrence of an event such as “touch”, “movement (slide)” or “release”. “Touch” is an event indicating that a pen contacts the screen. “Movement (slide)” is an event indicating that the contact position of the pen is moved while the pen is in contact with the screen. “Release” is an event indicating that the pen is lifted from the screen.

The handwriting input interface 300 is an interface configured to perform a handwriting inputting operation in cooperation with the digitizer 17c of the touch screen display 17. The handwriting input interface 300 receives a “touch” or “movement (slide)” event from the digitizer 17c of the touch screen display 17 to thereby detect a handwriting input operation. The “touch” event includes coordinates of the contact position. Also, the “movement (slide)” event includes coordinates of the moved contact position. Therefore, the handwriting input interface 300 can receives from the touch screen display 17, a coordinate string corresponding to a locus of movement of the contact position.

The display processor 301 receives the coordinate string from the handwriting input interface 300, and based on the coordinate string, displays on the screen of the LCD 17A stroke data input by handwriting by a handwriting input operation using the pen 100. Also, under control by the processor 305, the display processor 301 displays on the screen of the LCD 17A stroke data received from other terminals.

The stroke data generator 302 receives the above coordinate string from the handwriting input interface 300, and based on the coordinate string, generates time-series information having such a structure as explained in detail with reference to FIG. 8. In this case, the time-series information may be stored in the stroke database 52.

Under control by the processor 305, the transmission controller 303 executes a process for transmitting stroke data in the stroke database 12 to another terminal, using the transmitter 107A of the wireless communication device 107. Also, under control by the processor 305, the reception controller 304 executes a process for receiving stroke data from another terminal, using the receiver 107B of the wireless communication device 107.

The processor 305 executes a process for causing handwritten information to be shared among a plurality of terminals. The processor 305 includes a pen setting module 311, a member management module 312, a stroke management module 313, a display style management module 314, a state management module 315, etc.

The pen setting module 311 sets a display style (color, width, degree of transparency or pen type) of a stroke in accordance with an operation by the user. For example, the pen setting module 311 may cause a pen setting panel to be displayed on the canvas. The pen setting panel includes a user interface (UI) for selecting a pen type (ballpoint pen, pencil, marker, felt-tip pen, fountain pen), and a UI for selecting a pen color from a color pallet.

The pen setting panel may further include a UI for selecting a degree of transparency and width (stroke width).

When a style control function of switching a display style in accordance with a person is not operative, the display processor 301 can cause strokes input by handwriting to be displayed in a style (color, width, degree of transparency or pen type) set by the pen setting module 311. To stroke data stored in the stroke database 52, attribute information indicating the style (color, width, degree of transparency or pen type) set by the pen setting module 311 is added. Also, stroke data received from another terminal includes attribute information indicating a display style of the stroke data, which is added to the stroke data.

The member management module 312 manages members (participators) logging in to the handwriting sharing service. The member management module 312 can determine whether or not to permit a terminal requesting it to log in to the handwriting sharing service to log in thereto. In this case, the member management module 312 may inquire all the members whether or not permit the terminal to log in to the service. If the member management module 312 receives permissions to log in to the service from all the members, the member management module 312 may permit the terminal to log in to the service. Then, after receiving the permission from the member management module 312, the terminal is permitted to log in the handwriting sharing service, and connected to other terminals which log in to the handwriting sharing service.

The stroke management module 313 manages using the stroke database 52, stroke data received from the terminals participating in the handwriting sharing service, i.e., the terminals logging in to the service. The stroke management module 313 may be executed only in a terminal operating as a server.

The display style management module 314 manages a user ID (writer ID) and a display style of stroke data with respect to each of terminals (participators) logging in the service. In the terminal serving as the server, the display style management module 314 can prepare a display style list 51 as described above, which specifies the relationship between user IDs (writer IDs) and display styles of stroke data, and transmit the display style list 51 to the other terminals. During execution of the handwriting sharing service, the terminals can determine display styles of the stroke data, using the display style list 51.

The state management module 315 manages the connection states of the terminals. Also, the state management module 315 can prepare a connection status list 53 as described above, which indicates the connection states of the terminals, and transmit the connection status list 53 to the other terminals.

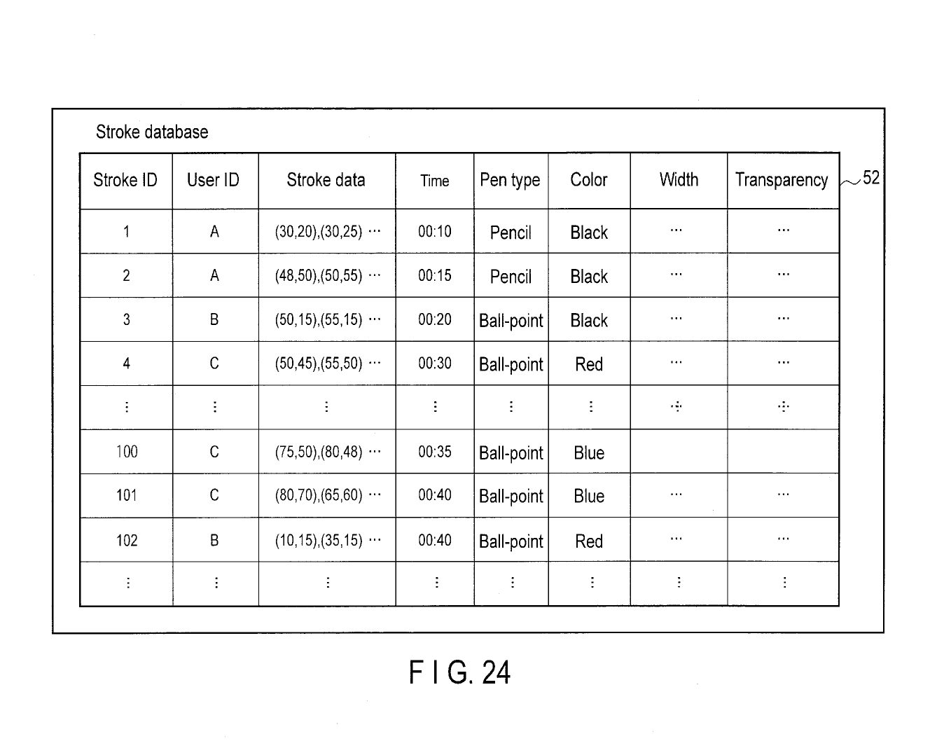

FIG. 24 shows contents of the stroke database 52 for the electronic device 10A.

The stroke database 52 includes a plurality of records (storage areas). To a single record, a single stroke data (single stroke) is assigned. In each of the records, a stroke ID, a user ID (terminal ID), stroke data (coordinate string), time, pen type, color, width, degree of transparency, etc., are stored. The time indicates time at which stroke data was input by handwriting or was received from another terminal. The pen type, color, width and degree of transparency are attribute information added to the stroke data. The pen type, color, width and degree of transparency are a display style set by user at each terminal, not a display style assigned to each terminal by the electronic device 10A.

Referring to FIG. 24, in the first two records, stroke data input by handwriting at the electronic device 10A (whose user ID is A) is stored. In the third record, stroke data input by handwriting by the terminal 10B (whose user ID is B) is stored. In the fourth record, stroke data input by handwriting at the terminal 100 (whose user ID is C) is stored.

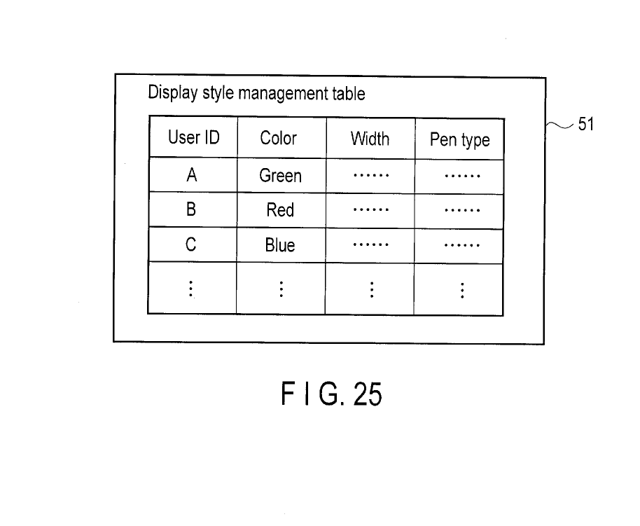

FIG. 25 shows a display style list (display style management table) 51 produced by the display style management module 314 in the terminal serving as the server.

The display style list 51, as described above, specifies a relationship between a user ID and a display style (color, width, pen type, degree of transparence or the like) of stroke data.

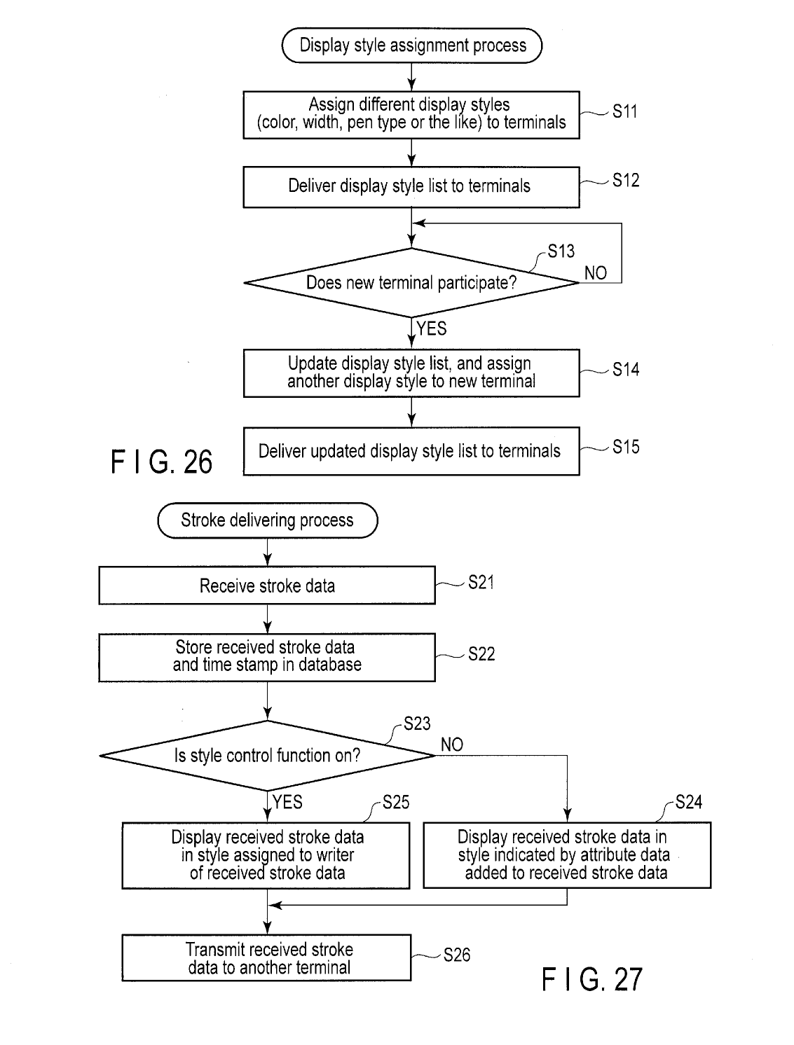

The flowchart of FIG. 26 shows a procedure of the display style assignment process.

The CPU 101 of the electronic device 10A assigns different display styles to a plurality of terminals (writers) logging in to the handwriting sharing service, respectively (step S11). Then, the CPU 101 prepares a display style list 51 indicating the display styles assigned to the terminals (writers), and delivers the display style list 51 to the terminals (step S12).

The CPU 101 determines whether a new terminal participates in (logs in to) the handwriting sharing service or not (step S13). If the new terminal participates in the handwriting sharing service (Yes in step S13), the CPU 101 updates the display style list 51 (step S14). In step S14, the CPU 101 first refers to the display style list 51, which has not yet been updated, and determines another display style differing from display styles presently applied. For example, a color different from presently applied colors is determined as another display style. The CPU 101 assigns the determined display style to the new terminal. The CPU 101 updates the display style list 51 to add to the display style list 51 a set of the new terminal and the display style assigned to the new terminal. Then, the CPU 101 delivers the updated display style list 51 to the terminals (step S15).

The flowchart of FIG. 27 shows a procedure of the stroke delivering process.

In cooperation with the receiver 107B, the CPU 101 of the electronic device 10A receives from any one of the terminals of a plurality of participators logging in to the service, stroke data corresponding to a stroke input by handwriting at the any one of the terminals (step S21). As described above, the stroke data includes writer information (user ID or terminal ID) and attribute information, which are added to the stroke data.

The CPU 101 stores in the stroke database 52, the received stroke data and a time stamp (time information) indicating time at which the stroke data was input by handwriting or received (step S22).

The CPU 101 determines whether the style control function is operative (on) or not (step S23). If the style control function is not operative, the CPU 101 executes a process for displaying the received stroke data in a style (color, width, pen type, degree of transparency, etc.) specified by the attribute information added to the stroke data (step S24). On the other hand, if the style control function is operative, the CPU 101 executes a process for displaying the received stroke data in a style (color, width, pen type, degree of transparency or the like) assigned to a writer for the stroke data (step S25).

Thereafter, the CPU 101 transmits the received stroke data to another terminal, using the transmitter 107A (step S26). The stroke data transmitted to the above another terminal includes writer information (user ID or terminal ID), attribute information and time information, which are added to the stroke data.

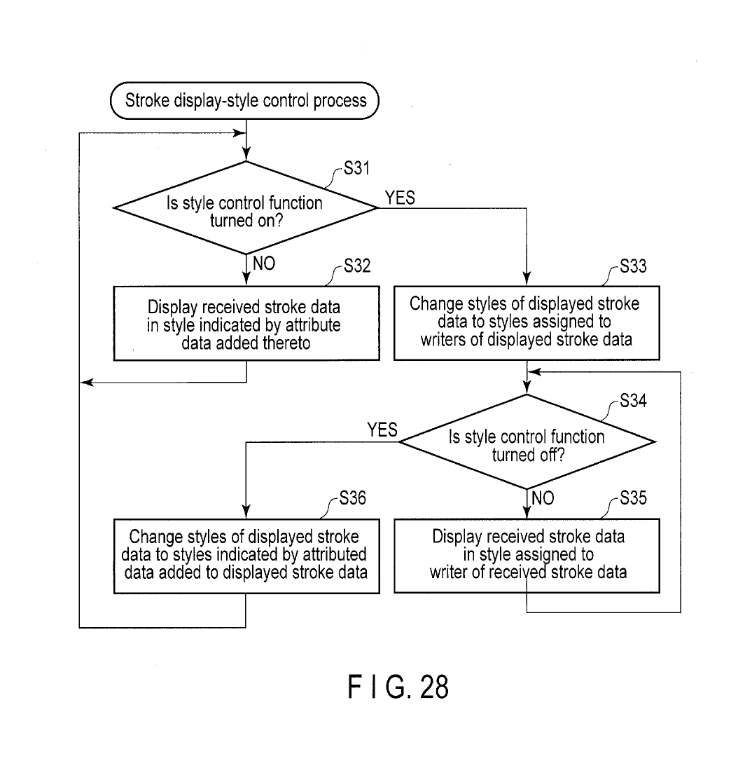

The flowchart of FIG. 28 shows a procedure of the stroke display-style control process.

The following explanation is given with respect to the case where the style control function is switched inoperative (off), operative (on) and inoperative (off) in this order.

The CPU 101 of each of the terminals determines whether the style control function is operative (on) or not (step S31). Since the style control function is inoperative, the process thus proceeds to step S32.

In step S32, the CPU 101 causes received stroke data to be displayed in a style specified by attribute information added to the stroke data. While the style control function is inoperative, the process of step S32 is executed each time new stroke data is received.

In the above state (off), when the style control function is switched operative (on) (Yes in step S31), the CPU 101 changes the display style of displayed each stroke data to a display style assigned to a writer for the each stroke data (step S33). Thereby, for example, all stroke data of a certain writer are displayed in the same color assigned to the writer. Also, all stroke data regarding another writer are displayed in the same color assigned to the above other writer and different from that color assigned to the above certain writer.

The CPU 101 determines whether the style control function is turned off or not (step S34). While the style control function is operative, the CPU 101 causes received stroke data to be displayed in a style assigned to a writer for the stroke data (step S35). That is, while the style control function is operative, the process of step S35 is executed each time new stroke data is received.

In the above state (on), when the style control function is switched inoperative (off) (Yes in step S34), the CPU 101 changes the display style of displayed stroke data to a display style specified by attribute information added to the stroke data (step S36). Thereby, for example, individual stroke data is displayed in respective original colors.

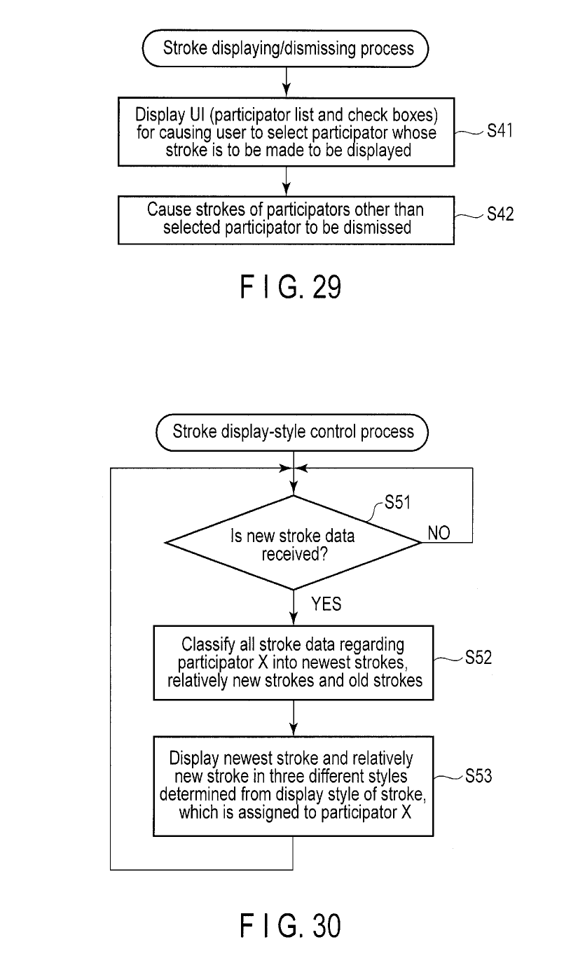

The flowchart of FIG. 29 shows a procedure of a stroke displaying/dismissing process.

The CPU 101 of each of the terminals causes a user interface (UI) to be displayed, the UI being provided to cause the user to select a participator inputting a stroke or strokes which the user wishes to have displayed, in accordance with an operation by the user (step S41). The CPU 101 dismisses stroke data of participators other than the selected participator (step S42).

The flowchart of FIG. 30 shows a procedure of a process for controlling display styles of strokes based on times at which they were input by handwriting.

When receiving new stroke data (Yes in step S51), the CPU 101 of each of the terminals executes the following processes with respect to each of all participators. Suppose a target participator is a participator X. Based on time information of each of all stoke data regarding the participator X or the order of arrangement of all those stroke data in the database, the CPU 101 classifies all the stroke data into a plurality of groups (step S52). The plural groups are, for example, three groups including a newest stroke group, a relatively new stroke group and an old stroke group. Each of the groups consists of a predetermined number of strokes (N strokes). N is an integer of one or more.

The CPU 101 causes the three stroke groups to be displayed in respective display styles (step S53). In step S53, the CPU 101 may cause the three stroke groups to be displayed in different display styles determined from a display style assigned to the participator X. For example, if the display style assigned to the participator X is red, strokes belonging to the newest stroke group are displayed in very bright red; strokes belonging to the relatively new stroke group are displayed in bright red; and strokes belonging to the old stroke group are displayed in ordinary red.

When subsequent new stroke data is received (Yes in step S51), in step S52, the stroke groups are updated. To be more specific, the subsequent new stroke data is added to the newest stroke group, and the oldest stroke data in the newest stroke group is moved to the relatively new stroke group. Also, the oldest stroke data in the relatively new stroke group is moved to the old stroke group.

It should be noted that although the above explanation is given with respect to the case where the strokes input by the participator X are classified into three groups, the CPU 101 may cause only the newest stroke input by the participator X to be displayed in a different display style from those of the other strokes input by the participator X.

Furthermore, the CPU 101 can regard stroke data which has not yet been viewed by the user as the newest stroke data. For example, there is a case where the size of the canvas is larger than that of a physical screen. The participator of each of the terminals can view an arbitrary display area in the canvas by scrolling the canvas vertically or horizontally with a finger gesture such as a flick. Thus, if a display area in the canvas which a given participator is viewing is different from that in the canvas which another participator is inputting stroke data by handwriting, the given participator cannot view the stroke data input by the above other participator unless the given participator scrolls the canvas. Thus, while a given display area in the canvas is being viewed, if the participator X inputs some stroke data by handwriting to another display area in the canvas, all those stroke data may be handled as newest strokes when the above other display area is made displayed by a vertical and horizontal scroll. In this case, those stroke data is all displayed in brightest red.

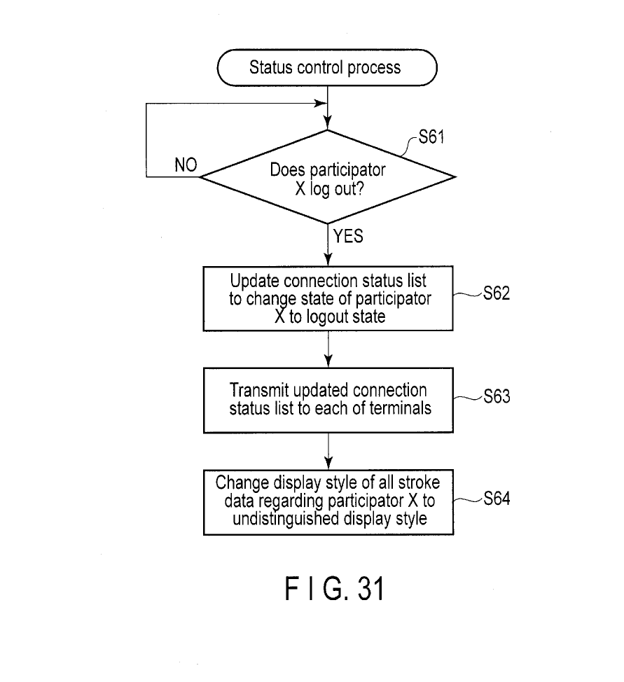

The flowchart of FIG. 31 shows a procedure of a status control process.

While the handwriting sharing service is being executed, the CPU 101 of the electronic device 10A determines whether the participator X logs out from the service or not (step S61). If the participator X logs out (Yes in step S61), the CPU 101 updates the connection status list 53 to change the connection state of the participator X to the logout state (step S62). The CPU 101 transmits the updated connection status list 53 to the other terminals (step S63). Then, the CPU 101 changes the display style of all the stroke data input by the participator X to, e.g., an undistinguished display style (step S64). In step S64, the color of all the stroke data input by the participator X is changed to, e.g., gray.

Also, in the other terminals, the color of all the stroke data input by the participator X is changed to, e.g., gray.

The above explanation is given with respect to the case where the connection state of the participator X is changed from the login state to the logout state; however, also, in the case where the connection state of the participator X is changed from the login state to the temporary absence state or busy state, the color of all the stroke data input by the participator X may be changed to gray.

It should be noted that if the connection state of the participator X is changed from the logout state, the temporary absence state or the busy state back to the login state, the color of all the stroke data input by the participator X may be changed from gray back to its original color.

Next, a process in which stroke data is transferred between the terminals will be explained.

As a method for transmitting stroke data input by handwriting at a given terminal to the electronic device 10A, it is possible to apply a method in which each time a single stroke is input by handwriting, all stroke data corresponding to the stroke is transmitted at once.

Alternatively, it is possible to apply a method in which stroke data is transmitted in units of point data, not in units of stroke data.

In this case, the electronic device 10A receives from, e.g., the terminal 10B, a plurality of point data corresponding to a stroke input by handwriting at the terminal 10B. While the stroke is being input, the plurality of point data is subsequently transmitted from the electronic device 10B to the electronic device 10A on a time-series basis. That is, in the order in which the plurality of point data corresponding to the stroke is input, the plurality of point data is transmitted from the terminal 10B to the electronic device 10A one by one.

The electronic device 10A stores in the stroke database, the plurality of point data along with time information indicating times at which the plurality of point data was received. Also, the electronic device 10A draws point data each time it receives the point data. Therefore, also in the canvas of the electronic device 10A, it can be reproduced how a stroke input by handwriting at the electronic device 10B is drawn (how a line is extended).

Furthermore, the electronic device 10A successively transmits the plurality of point data to the terminal 10C on a time-series basis. In this case, each time single point data is received from the terminal 10B, the electronic device 10A may execute a process for transmitting the received point data to the terminal 10C.

As explained above, in the embodiment, in the status control process, if the state of a given terminal is changed from the login state to the logout state or to an intermediate state between the login state and the logout state, the display style of one or more first stroke data from the terminal is changed from a first style to a second style. It is therefore possible to display each of the strokes on the screen such that it can be determined whether each stroke is a stroke input by a user logging in to the service or a stroke input by a user logging out from the service or changing to the intermediate state. As a result, in consideration of the present connection states of the terminals, it is possible to present strokes input by a plurality of persons, respectively, in such a way as to enable the user to easily know which of the persons inputs each of the strokes.

In the embodiment, with respect to each of the persons, the display style of strokes can be switched by the style control function. It is therefore possible to present strokes to the user to enable him or her which person inputs each of the strokes.

In the embodiment, due to the stroke display-style control process, of strokes input by handwriting by the same participator, one or more stroke data input by handwriting in the first time period and one or more stroke data input by handwriting in the second time period subsequent to the first time period can be displayed in different styles. Therefore, it is possible to achieve a display on the canvas such that such new stroke data as the newest stroke is easily noted.

Also, in the embodiment, each of strokes can be displayed in a style specified by its attribute information, and the display style of each stroke can also be changed to a style assigned to a writer for each stroke. Furthermore, in the embodiment, by the stroke displaying/dismissing process, stroke data regarding a user not selected is dismissed. Therefore, only a stroke input by an arbitrary user can be displayed.

The above various functions regarding a display control of strokes can be combined.

It should be noted that each of he various functions described with respect to the embodiment may be realized by circuitry (processing circuitry). Examples of the processing circuitry include a programmed processor such as a central processing unit (CPU). This processor performs each of the above described functions by executing a computer program (a group of commands) stored in a memory. As the processor, a microprocessor including circuitry may be applied. The examples of the processing circuitry also include a digital signal processor (DSP), an application-specific integrated circuit (ASIC), a microcontroller, a controller and another circuitry component. Each of the components other than the CPU, which are described with respect to the embodiment, may also be realized by the processing circuitry.

Since each of the processes in the embodiment can be realized by a computer program, it is possible to easily obtain the same advantages as in the embodiment simply by installing the above computer program onto a computer with a computer-readable storage medium storing the computer program.

A CPU provided in the computer onto which the above computer program is installed can function as a processor configured to perform each of the above functions. A display controller in the computer can functions as a display processor configured to display each of strokes on a screen.

Furthermore, although the above explanation is given by referring to by way of example the case of using the tablet computer, each of the functions in the embodiment can also be realized by an ordinary desktop personal computer. In this case, it suffices that a tablet, which is an input device for inputting by handwriting, or the like, is connected to the desktop personal computer.

In addition, each of the status control process, the style control function, the stroke display-style control process, the stroke displaying/dismissing process, etc., in the embodiment can be applied to an arbitrary system which can display handwriting data received from each of terminals which are in the logon state, on the screen of another one of the terminals.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to receive first stroke data from a first terminal logging in to a service for sharing handwritten information, and second stroke data from a second terminal logging in to the service, the first stroke data corresponding to one or more strokes that are input by handwriting at the first terminal, the second stroke data corresponding to one or more strokes that are input by handwriting at the second terminal; and
circuitry configured to execute a process for displaying the first and second stroke data on a screen, and to change a display style of the first stroke data from a first style to a second style different from the first style when a state of the first terminal is changed from a login state to a logout state, or from the login state to an intermediate state between the login state and the logout state.

2. The electronic apparatus of claim 1, wherein
the circuitry is further configured to execute a process for displaying the first stroke data and the second stroke data in different styles based on information for assigning different display styles to a user of the first terminal and a user of the second terminal, respectively, and
the first style is a style assigned to the user of the first terminal.

3. The electronic apparatus of claim 1, wherein the circuitry is further configured to execute a process for displaying third stroke data and fourth stroke data in different styles, third stroke data corresponding to one or more strokes input by handwriting in a first time period at the first terminal, the fourth stroke data corresponding to one or more strokes input by handwriting in a second time period subsequent to the first time period at the first terminal.

4. The electronic apparatus of claim 1, wherein the circuitry is further configured to:
execute a process for displaying the first stroke data in a style specified by attribute information added to the first stroke data, and for displaying the second stroke data in a style specified by attribute information added to the second stroke data; and
change the display style of the first stroke data to a style assigned to a user of the first terminal and to change a display style of the second stroke data to a style assigned to a user of the second terminal, when a function of displaying the first stroke data and the second stroke data in different styles is made operative.

5. The electronic apparatus of claim 1, wherein the circuitry is further configured to:
execute a process for displaying on the screen a user interface for selecting a user whose stroke date is to be displayed from a user of the first terminal and a user of the second terminal; and
execute a process for causing either the first stroke data or the second stroke data of the unselected user to not be displayed.

6. A method comprising:
receiving first stroke data from a first terminal logging in to a service for sharing handwritten information, and second stroke data from a second terminal logging in to the service, the first stroke data corresponding to one or more strokes that are input by handwriting at the first terminal, the second stroke data corresponding to one or more strokes that are input by handwriting at the second terminal;
displaying on a screen the first stroke data and the second stroke data; and
changing a display style of the first stroke data from a first style to a second style different from the first style when a state of the first terminal is changed from a login state to a logout state, or from the login state to an intermediate state between the login state and the logout state.

7. The method of claim 6, wherein
the displaying comprises displaying the first stroke data and the second stroke data in different styles based on information for assigning different display styles to a user of the first terminal and a user of the second terminal, respectively; and
the first style is a style assigned to the user of the first terminal.

8. The method of claim 6, wherein the displaying comprises displaying third stroke data and fourth stroke data in different styles, third stroke data corresponding to one or more strokes input by handwriting in a first time period at the first terminal, the fourth stroke data corresponding to one or more strokes input by handwriting in a second time period subsequent to the first time period at the first terminal.

9. The method of claim 6, wherein the displaying comprises displaying the first stroke data in a style specified by attribute information added to the first stroke data, and for displaying the second stroke data in a style specified by attribute information added to the second stroke data, and
the method further comprises:
changing the display style of the first stroke data to a style assigned to a user of the first terminal and changing a display style of the second stroke data to a style assigned to a user of the second terminal, when a function of displaying the first stroke data and the second stroke data in different styles is made operative.

10. The method of claim 6, further comprising:
displaying on the screen a user interface for selecting a user whose stroke date is to be displayed from a user of the first terminal and a user of the second terminal; and
causing either the first stroke data or the second stroke data of the unselected user, to not be displayed.

11. A computer-readable, non-transitory storage medium having stored thereon a computer program which is executable by a computer, the computer program controlling the computer to execute functions of:
receiving first stroke data from a first terminal logging in to a service for sharing handwritten information, and second stroke data from a second terminal logging in to the service, the first stroke data corresponding to one or more strokes that are input by handwriting at the first terminal, the second stroke data corresponding to one or more strokes that are input by handwriting at the second terminal;
displaying the first stroke data and the second stroke data on a screen; and
changing a display style of the first stroke data from a first style to a second style different from the first style when a state of the first terminal is changed from a login state to a logout state, or from the login state to an intermediate state between the login state and the logout state.

12. The storage medium of claim 11, wherein the displaying comprises displaying the first stroke data and the second stroke data in different styles based on information for assigning different display styles to a user of the first terminal and a user of the second terminal, respectively; and
the first style is a style assigned to the user of the first terminal.

13. The storage medium of claim 11, wherein the displaying comprises displaying third stroke data and fourth stroke data in different styles, third stroke data corresponding to one or more strokes input by handwriting in a first time period at the first terminal, the fourth stroke data corresponding to one or more strokes input by handwriting in a second time period subsequent to the first time period at the first terminal.

14. The storage medium of claim 11, wherein the displaying comprises displaying the first stroke data in a style specified by attribute information added to the first stroke data, and displaying the second stroke data in a style specified by attribute information added to the second stroke data, and
the computer program further controls the computer to execute of a function of changing the display style of the first stroke data to a style assigned to a user of the first terminal and changing a display style of the second stroke data to a style assigned to a user of the second terminal, when a function of displaying the first stroke data and the second stroke data in different styles is made operative.

15. The storage medium of claim 11, wherein the computer program further controls the computer to execute functions of:
displaying on the screen a user interface for selecting a user whose stroke date is to be displayed from a user of the first terminal and a user of the second terminal; and
causing either the first stroke data or the second stroke data of the unselected user, to not be displayed.
